(19) United States
(12) Patent Application Publication
(10) Pub. No.: US 2006/0045998 A1
(43) Pub. Date: Mar. 2, 2006

(54) Ink jet recording material

(76) Inventors: Ryu Kitamura, Kanagawa (JP); Hirokazu Sunagawa, Tokyo (JP); Mitsuru Kobayashi, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/535,848

(22) PCT Filed: Nov. 21, 2003
(86) PCT No.: PCT/JP03/14942

§ 371 Date: May 20, 2005

(30) Foreign Application Priority Data
Nov. 22, 2002 (JP) 2002-338767

(51) Int. Cl. B41M 5/00

(52) U.S. Cl. 428/32.24; 428/32.34

(57) ABSTRACT

An ink jet recording material having excellent ink-absorption and appropriate for high speed recording has an ink receiving layer formed on a substrate material and including a first coating layer formed on the substrate material and including a pigment (for example, wet process silica fine particles) and a binder; a second coating layer formed on the first coating layer and including a pigment (for example, gas phase process silica or alumina) and a binder; and a third coating layer formed on the second coating layer and including a pigment containing colloidal particles, and alumina and/or pseudo boehmite fine particles.

### TECHNICAL FIELD

The present invention relates to an ink jet recording material. More particularly, the present invention relates to art ink jet recording material having a high absorption of an ink containing a dye or a pigment, capable of recording ink images with high accuracy and clarity and appropriate to high speed printing.

### BACKGROUND ART

An ink jet recording system in which an aqueous ink is ejected toward an ink jet recording material through a fine ejection nozzle to form images on a surface of the ink jet recording material is widely utilized for a terminal printer, a facsimile machine, or a trade book and slip-printing machine, due to advantages that the noise made in recording is low, full-colored images can be easily formed, high speed printing can be carried out, and the recording cost is cheaper than that of other printing apparatuses.

Currently, due to the popularity and the developments in precision and speed of the printer, the recording material is now facing a requirement of further enhancement of ink-absorbing rate and, due to the appearance of the digital camera, the recording material is further facing a strong requirement of realizing recorded images having a high uniformity comparable to that of the silver-salt-type photograph. Furthermore, an improvement in color density and gloss of the recorded images is required to bring the quality of the ink jet recording images close to that of the photographic images.

Japanese Unexamined Patent Publication No. 58-110287 (Patent Reference 1) discloses that, in order to obtain a high ink absorption rate, a one- or more-layered ink receiving layer is provided in an ink jet recording material, and the ink receiving layer is designed so that the uppermost layer exhibits a pore size-distribution curve having a peak located in the range of from 0.2 to 10 μm of the pore size and the ink receiving layer exhibits, as a whole, a pore size distribution curve having at least two peaks located in the ranges of from 0.2 to 10 μm and from 0.05 μm or less. In this case, the enhancement effect on the ink absorption rate is significant. However, in the production of this type of ink jet recording material, it is indispensable that the coating layer (ink receiving layer) is designed so that a pigment having a particle size of a micrometer order is contained as a principal component. The use of the pigment having a particle size in a micrometer order causes the resultant ink jet recording material to exhibit a poor gloss and a low color density of images, and the recorded image dots to have an insufficient roundness, and thus the recorded images exhibit a very low uniformity.

Japanese Unexamined Patent Publication No. 9-183267 (Patent Reference 2) discloses that in order to enhance gloss, color density of images and uniformity of the images, a pigment having a particle size of a sub-micrometer order is introduced in an ink receiving layer to control the location of a peach in a pore size distribution curve of the ink receiving layer to a range of 100 nm (0.1 μm) or less.

Japanese Unexamined Patent Publication No. 10-71764 (Patent Reference 3) discloses an ink jet recording material in which a pigment having a particle size of a submicrometer order is introduced into an ink receiving layer to improve gloss, color density of images and uniformity of images, and the location of a peak in a pore size distribution curve of the ink receiving layer is controlled in a range of 100 nm (0.1 μm) or less by using a secondary colloidal particles of a pigment. In this case, the ink absorption rate is significantly improved but the uniformity of the images is still insufficient. Also, in this case, the production of the recording material is costly because the pigment having a particle size in the sub-micrometer order is expensive and causes it to be very difficult to prevent cracking of the layer occurring when it is formed by coating. Japanese Unexamined Patent Publication No. 7-117334 (Patent Reference 4) discloses that cracking of a coating layer is controlled by using fine pigment particles having an average particle size of 0.1 μm or less. In this case, the resultant ink jet recording material exhibits a high gloss, a high color density of images and a very high uniformity of the images. However, in view of a significant progress in printing speed of the printers, the ink jet recording material in this case is greatly disadvantageous in the ink absorption rate.

Japanese Unexamined Patent Publication No. 10-119423 (Patent Reference 5) discloses an ink jet recording material in which a hardening agent for a coating layer capable of cross-linking with a binder in the coating layer is introduced into the ink receiving layer. In this case, all pore spaces are formed from pigment particles having a particle size in a sub-micrometer order and, thus, the ink absorption rate of the ink receiving layer is still insufficient. Also, making all the ink receiving layers contain the pigment having a sub-micrometer order size is costly.

The inventors of the present invention have disclosed in Japanese Unexamined Patent Publication No. 2001-341412 (Patent Reference 6) that boric acid is contained in a coating layer in an ink jet recording material for the purpose of improving a light resistance of the recorded images. In this case, the control of the ink absorption rate by controlling the location of a peak in the pore size distribution curve of each coating layer has not been considered and therefore when the ink jet recording material has been used in the new type of photoprinter in which the ink has been used in a large amount, a problem, that the ink jet recording material has been insufficient in the ink absorption rate, has occurred.

Japanese Unexamined Patent Publication No. 7-276789 (Patent reference 7), No. 8-174992 (Patent Reference 8) and No. 9-97662 (Patent Reference 9) disclose that in designing an ink jet recording material in which a high transparency and gloss are considered very important, the pore size distribution is controlled to about 50 nm (0.05 μm) or less by using a pigment having a particle size in a sub-micrometer order in all of the ink receiving layers. In this case, however, a high ink absorption rate could not be attained.

Japanese Unexamined Patent Publication No. 3-96333 (Patent Reference 10) discloses a pore size distribution curve having a peak located in the range of from 0.06 to 2.0 μm. However, when the pore size of a porous layer in which a dye is fixed is controlled to 0.06 to 2.0 μm, the resultant ink dots exhibit a degraded roundness, and the uniformity of the images is decreased.

The ink jet recording material of the present invention comprises a substrate material and an ink-receiving layer which comprises a first coating layer formed on the front surface of the substrate material and comprising a pigment and a binder, a second coating layer formed on the first coating layer, comprising a pigment and a binder and being in one or more-layered form, and a third coating layer formed on the second coating layer,
wherein the third coating layer comprises a pigment comprising, as a principal component, at least one member selected from the group consisting of primary colloidal particles having an average particle size of 0.01 to 0.06 μm, and fine alumina and pseudo boehmite particles having an average particle size of 0.01 to 1 μm.

In the ink jet recording material of the present invention, the first coating layer preferably exhibits a pore size-distribution curve having at least one peak located in the range of from 0.1 to 10 μm of the pore size, and the second coating layer preferably exhibits a pore size-distribution curve having a peak located in the range of about 0.06 μm or less of the pore size.

In the ink jet recording material of the present invention, the first coating layer preferably exhibits a pore size-distribution curve having at least one peak located in each of the ranges of 0.04 μm or less and from 0.2 to 5 μm of the pore size, and the second coating layer preferably exhibits a pore size-distribution curve having a peak located in the range of about 0.04 μm or less of the pore size.

In the ink jet recording material of the present invention, preferably, the binders for the first and second coating layers respectively, and independently from each other, comprise at least one member selected from the group consisting of polyvinyl alcohol, modified polyvinyl alcohols and cross-linked polyvinyl alcohols with a cross-linking compound.

In the ink jet recording material of the present invention, the binder preferably contained in the second coating layer preferably comprises cross-linked polyvinyl alcohol having a degree of polymerization of 2000 or more.

In the ink jet recording material of the present invention, the cross-linking compound with which the polyvinyl alcohol is cross-linked, is preferably a boron-containing compound.

In the ink jet recording material of the present invention, preferably, the pigment contained in the first coating layer comprises, as a principal component, secondary pigment particles composed of agglomerates of primary particles having an average primary particle size of 0.003 to 0.04 μm and having an average secondary particle size of 0.7 to 3 μm; the pigment contained in the second coating layer comprises, as a principal component, secondary pigment particles composed of agglomerates of primary particles having an average primary particle size of 0.003 to 0.04 μm and having an average secondary particle size of 0.7 μm or less; and the pigment contained in the third coating layer comprises at least one member selected from the group consisting of the above-mentioned primary colloidal particles and alumina and pseudo boehmite fine particles.

In the ink jet recording material of the present invention, preferably, the pigment contained in the second coating layer comprises at least one member selected from the group consisting of silica, aluminum oxides and pseudo boehmite, and the second coating layer has a pore volume of 0.3 to 1 ml/g.

In the ink jet recording material of the present invention, preferably, the first and second coating layers comprise, as a pigment, silica, and the silica contained in the first coating layer is a wet process silica, and the silica contained in the second coating layer is a dry process silica.

In the ink jet recording material of the present invention, preferably, the silica contained in the second coating layer is included in agglomerate particles of the dry process silica particles with a cationic compound, and the silica-cationic compound agglomerate particles have an average particle size of 0.7 μm or less.

In the ink jet recording material of the present invention, the second coating layer preferably has a smooth surface formed by pressing the second coating layer kept in a wetted condition onto a heated mirror-finished drum surface and drying the pressed layer.

In the ink jet recording material of the present invention, the third coating layer preferably has a smooth surface formed by pressing the third coating layer kept in a wetted condition onto a heated mirror-finished drum surface and drying the pressed layer.

In the ink jet recording material of the present invention, preferably the pigment contained in the second coating layer comprises at least one member selected from the group consisting of gas phase process silica, mesoporous silica, dispersed secondary silica particles having a specific surface area of 100 to 400 m²/g determined by a nitrogen absorption method, an average secondary particle size of 20 to 300 nm and a pore volume of 0.5 to 2.0 ml/g, aluminas and alumina hydrates.

In the ink jet recording material of the present invention, preferably the pigment contained in the first coating layer comprises wet process silica fine particles;
the second coating layer comprises at least one member selected from the group consisting of gas phase process silica and mesoporous silica fine particles having an average particle size of 0.01 to 1 μm, secondary silica particles having a specific surface area of 100 to 400 m²/g determined by a nitrogen absorption method, an average secondary particle size of 20 to 300 nm and a pore volume of 0.5 to 2.0 ml/g, and alumina and alumina hydrate fine particles having an average particle size of 0.01 to 1 μm; and the third coating layer comprises at least one member selected from the group consisting of alumina and pseudo boehmite fine particles having an average particle size of 0.1 to 0.7 μm.

In the ink jet recording material of the present invention, the binder contained in the second coating layer is preferably thickening-treated or cross linking-treated.

In the ink jet recording material of the present invention, the thickening or cross-linking treatment for the binder contained in the second coating layer is preferably applied to a binder-containing coating liquid for forming the second coating layer simultaneously with the application of the coating liquid to the second coating layer or before the applied coating liquid in a step of drying exhibits a falling rate of drying.

In the ink jet recording material of the present invention, the thickening- or cross linking-treated binder contained in the second coating layer preferable comprises a hydrophilic resin hydrogelled by an electron beam-irradiation.

In the ink jet recording material of the present invention, the substrate material preferably exhibits a gas permeation resistance of 500 seconds/100 ml or less, determined in accordance with JIS P8117.

In the ink jet recording material of the present invention, the an permeability of the substrate material is preferably in the range of from 10 to 200 seconds/100 ml.

The ink jet recording material of the present invention preferably has a total air permeability of 2 to 12 times that of the substrate material.

The ink jet recording material of the present invention preferably has a total air permeability of 2 to 12 times that of a laminate consisting of the substrate material and the first coating layer.

The ink jet recording material of the present invention optionally further comprises an other coating layer formed on a back surface of the substrate material.

In the ink jet recording material of the present invention, the other coating layer may be a laminated layer comprising a polyethylene.

### DISCLOSURE OF THE INVENTION

An object of the present invention is to provide an ink jet recording material having a high ink absorption performance (high ink absorption rate and a high ink absorption capacity) and thus free from occurrence of beading phenomenon even at a high speed recording; capable of recording ink images having a high dot roundness, and high color density, clarity and uniformity; and having a high gloss.

The above-mentioned object can be attained by the ink jet recording material of the present invention.

The ink jet recording material of the present invention can absorb a dye or pigment-containing ink with a high absorption with a high dot roundness, and thus is usable for a high speed recording, and exhibits excellent accuracity, clarity and uniformity of the recorded images and a high gloss.

### BEST MODE FOR CARRYING OUT THE INVENTION

Substrate Material

For a substrate material for the ink jet recording material of the present invention, for example, films, for example, viscose films, (CELLOPHANE (trademark)) and polyethylene, polypropylene, soft polyvinyl chloride, hard polyvinyl chloride, and polyester films; paper sheets, for example, woodfree paper sheets, art paper sheets, coated paper sheets, cast-coated paper sheets, foil paper sheets, kraft paper sheets, baryta paper sheets, polyethylene-laminated paper sheets, impregnated paper sheets, metallized paper sheets, and water-soluble paper sheets; single sheets for example, metal foils and synthetic paper sheets, and composite sheets of two or more of the single sheets.

To impart photographic printing sheet-like appearance, art paper sheets, coated paper sheets, baryla paper sheets and polyethylene laminated paper sheets (particularly paper sheets laminated with a polyethylene resin knead-mixed with titanium dioxide, referred to as RC paper sheet) are preferably employed as a substrate material.

In the ink jet recording material of the present invention, in order to obtain a good ink absorption property (ink absorption rate and ink absorption capacity) by which an occurrence of a beading phenomenon is prevented even during high-speed recording, preferably no water-nonpermeable layer is formed between the substrate material and a first coating layer and a solvent contained in the ink can be absorbed in the substrate material. The inventors of the present invention have found that a good ink absorption can be imparted to the recording material and the beading phenomenon on the recording material can be prevented even at a high speed recording by establishing an air permeation resistance of the substrate material in a range of 500 seconds/100 ml or less, preferably from 10 to 200 seconds/100 ml. More preferably the air permeation resistance of the substrate material is in the range of from 20 to 100 seconds/100 ml, in consideration of a cockling phenomenon of the paper sheet. If the air permeability is more than 500 seconds/100 ml, the resultant substrate material may exhibit a significantly decreased ink absorption. If the air permeation resistance is too low, the resultant recording material may be cockled.

There is no limitation to the type of the substrate material as long as the air permeability thereof is 500 seconds/100 ml or less, and paper sheets and porous films can be used as a substrate material. The air permeability of the ink jet recording material of the present invention is preferably 2 to 12 times, more preferably 3 to 8 times, that of the substrate material and 2 to 12 times, more preferably 3 to 8 times, the total air permeation resistance of a laminate of the substrate material with the first coating layer.

When the air permeability of the ink jet recording material is, as a whole, controlled in the range of from 2 to 12 times that of the substrate material, the penetration rate of the dye or pigment in the ink into the ink receiving layer can be appropriately controlled, the dye or pigment in the ink can be fixed in a portion of the ink receiving layer close to a front surface of the recording material, the solvent component in the ink can be rapidly absorbed in the coating layer or the paper, and the occurrence of a beading phenomenon can be prevented even in the high speed recording. If the difference in the permeability between the recording material and the substrate material is too small, the dye or pigment in the ink is ready to fix to a deep portion of the ink receiving layer from the front surface thereof, and thus a problem that the recorded images do not have a high color density, occurs.

On other hand, if the difference in permeability between the recording material and the substrate material is too large, the ink absorption rate is affected.

Further, when the air permeability resistance of the recording material is controlled in the range of from 2 to 12 times that of the laminate of the substrate material with only the first coating layer, most of the dye or pigment in the ink can be fixed in the second coating layer and the solvent component in the ink can be rapidly absorbed in the first coating layer and the substrate material. In this case, the ink images having increased clarity and color density can be recorded.

Constitution of Ink Receiving Layer

In the ink jet recording material of the present invention, an ink receiving layer is formed on at least one surface of a substrate material.

The above-mentioned ink receiving layer comprises a first coating layer formed on the substrate material and comprising a pigment and a binder; at least one second coating layer formed on the first coating layer and comprising a pigment and a binder; and a third coating layer formed on the second coating layer.

The first coating layer has a principal function to rapidly separate and absorb a solvent from the ink. The second coating layer has a principal function to uniformly fix a dye or pigment in the ink thereto and allow the solvent in the ink to pass to the first coating layer therethrough. Namely, the second coating layer enables the dye or pigment in the ink to be rapidly fixed to the second coating layer to form dot images having high color density and dot roundness and thus high clarity and uniformity. The third coating layer has a principal function to impart a high gloss to the recording surface of the recording material, and thus the function of the third coating layer for fixing the dye or pigment in the ink thereto may be low.

In the ink receiving layer of the ink jet recording material of the present invention, the first to third coating layers respectively bear functions different from each other, and thus the resultant ink jet recording material can exhibit a high ink absorption rate and an extremely excellent image uniformity.

In the ink jet recording material of the present invention, it is important that, on the first and second coating layers having the above-mentioned functions, the third coating layer is further formed to provide a recording surface of the recording material having high gloss and transparency, without hindering the functions of the first and second coating layers.

First to Third Coating Layers

Each of the first to third coating layers contains a pigment and a binder. The third coating layer contains the above-mentioned specific pigment and optionally further contains a binder.

There is no specific limitation to the pigments and binders contained in the first and second coating layers, as long as they can exhibit the above-mentioned functions.

The binders for the first and second coating layer preferably comprise, respectively and independently from each other, at least one member selected from polyvinyl alcohol (for example, having a degree of polymerization of 1500 to 5000 and a degree of saponification of 85 to 100%), modified polyvinyl alcohols (for example, silyl-modified polyvinyl alcohols) and polyvinyl alcohols treated with cross-linking compounds.

In order that the first coating layer exhibits a high receiving property therein and a high permeating property therethrough for the solvent of the ink, and the second coating layer exhibits a high fixing property thereto for the dye or pigment of the ink and a high permeating property therethrough for the solvent of the ink, either one binder of the first and second coating layers preferably comprises a polyvinyl alcohol cross-linked with a cross-linking compound. When the polyvinyl alcohol contained, as a binder component, in the first and second coating layers is cross-linked, the resultant cross-linked coating layer exhibits a significantly enhanced film-forming property and, when the binder (namely polyvinyl alcohol) is hardened, with the cross-linking compound, an influence of water in the ink on swelling of polyvinyl alcohol is lost or decreased to maintain the pore passages to allow the ink to pass therethrough when the ink is absorbed in the first and second coating layers, to increase the ink separation effect and to prevent cracking of the first and second coating layers.

The compounds having a cross-linking property for the polyvinyl alcohol include, for example, cross-linking aldehyde compounds, for example, glyoxal; cross-linking epoxy compounds, for example, ethyleneglycolglycidylether; cross-linking vinyl compounds, for example, bisvinylsulfonylmethylether; aluminum alums; and boron-containing compounds for example, boric acid and borax. For the present invention, the boron-containing compounds which exhibit excellent hardening effect for coating layer are preferably employed. Among the compounds, borax is more preferably employed.

For the binders for the first and second coating layers (and optionally for the binders for the third coating layer, the above-mentioned polyvinyl alcohol, modified polyvinyl alcohol and/or cross-linked polyvinyl alcohols may be employed together with an another water-soluble resins, to improve the stability of the coating liquids and the ink-absorption. For example, as the another water-soluble resins include polyvinyl pyrrolidone, casein, soybean protein, synthetic proteins, starch, cellulose derivatives, for example, carboxymethylcellulose and methylcellulose. Also, a water-dispersible adhesive, for example, a polymer latex or a synthetic resin emulsion may be contained in the coating liquids.

The pigments contained in the first and second coating layers include well-known pigments for coated paper sheets, for example, gas phase process silica, mesoporous silica, wet process silica, secondary silica particle dispersion (disclosed in Japanese Unexamined Patent Publication No. 2001-354408) prepared by mixing an alkali into a silica seed liquid in which the silica seeds are dispersed in colloidal form, then a feed liquid comprising at least one member selected from an aqueous activated silica acid solution and alkoxysilanes is mixed little by little to the seed liquid to allow the silica fine particles to grow; colloidal silica, alumina oxides, alumina hydrates, alumina silicates, kaolin, clay, calcined clay, zinc oxide, tin oxide, magnesium sulfate, aluminum hydroxide, calcium carbonate, satin white, aluminum silicate, smectites, zeolites, magnesium silicate, magnesium carbonate, magnesium oxide, diatomeceous earth, stylene plastic pigments, and urea resin plastic pigments. The above-mentioned pigments are usable alone or in a mixture of two or more thereof.

The pigments for the first coating layer are preferably selected from agglomerate pigments having a good ink absorption. For example, agglomerate pigments include, for example, gas phase process silica, mesoporous silica, wet process silica, secondary silica particle dispersion prepared by mixing an alkali into a silica seed liquid in which the silica seeds are dispersed in colloid form, and then into the seed liquid, a feed liquid containing at least one member selected from aqueous solutions of activated silicic acid and alkoxysilanes is mixed little by little, to allow the resultant silica fine particles to grow; aluminas, alumina hydrates, alumina silicates and calcium carbonate.

The pigments for the second coating layer are preferably selected from agglomerate pigments having a particle size of 0.7 μm or less and exhibiting high color density and ink absorption. For example, the agglomerate pigments include gas phase process silica, mesoporous silica, wet process silica, secondary silica particle dispersion prepared by mixing an alkali into a silica seed liquid in which seed particles are dispersed in colloid form, and then into the resultant seed liquid, a feed liquid containing at least one member selected from aqueous solutions of activated silicic acid and alkoxysilanes is mixed little by little, to allow the resultant silica fine particles to grow; aluminas, alumina hydrates, alumina silicates and calcium carbonates.

The gas phase process silica usable for the first and second coating layers is referred to as fumed silica and is usually produced by a flame hydrolysis method. In practice, a method in which silicon tetrachloride is burnt together with hydrogen and oxygen to produce the gas phase process silica is commonly known. In this method, silicon tetrachloride may be replaced by a silane compound, for example, methyl trichlorosilane or trichlorosilane alone or a mixture of the silane compound with silicon tetrachloride.

The mesoporous silica usable for the present invention is in the form of porous silica particles having an average pore size of 1.5 to 100 nm. Also, as a mesoporous silica, an aluminum, titanium, vanadium, boron or manganium atom-introduced mesoporous silica can be used. There is no specific limitation to the properties of the mesoporous silica particles. Preferably, the mesoporous silica particles have a BET specific surface area (nitrogen absorption specific surface area) of 200 to 1500 m²/g and a pore volume of 0.5 to 4 ml/g.

There is no limitation to the methods of producing the mesoporous silica. The mesoporous silica production methods include a synthetic method disclosed in U.S. Pat. No. 3,556,725 in which a silica alkoxide is used as a silica-supply source, and a long chain alkyl group-containing quaternary ammonium salt is used as a template; an aqueous heating synthetic method disclosed Japanese Unexamined Patent Publication No. 5-503499 in which amorphous silica particles or an aqueous alkali metal silicate solution is used as a silica supply source and an long chain alkyl-containing quaternary ammonium or phosphonium salt is used as a template; an ion-exchange synthetic method disclosed in U.S. Pat. No. 5,171,626 in which a layer structured silicate salt, for example, canemite, is used as a silica-supply source, and long chain alkyl ammonium cations are used as a template; and a synthetic method in which an amine, for example, dodecylamine or hexadecylamine or a non-ionic surfactant is used as a template and an activated silica produced by an ion-exchange process of water glass is used as a silica supply source. As a method of removing the template from the nanoporous silica precursor, a combustion method at a high temperature and an extraction method with an organic solvent are known.

The secondary silica dispersion usable for the present invention can be produced by mixing a liquid dispersion of silica seeds in the form of colloid with an alkali, and into the resultant seed liquid, a feed liquid containing at least one member selected from aqueous activated silicic acid solutions and alkoxysilanes is mixed small by small so as to allow the resultant fine silica particles to grow up, in accordance with the process disclosed in Japanese Unexamined Patent Publication No. 2001-354408.

The aluminas usable for the present invention are selected from crystalline aluminas including Ω, κ, γ, θ, η, ρ, pseudo γ and α-crystalline aluminas. In the present invention, in view of gloss and ink absorption, the gas phase process alumina oxides and γ, δ and θ-crystalline aluminas are preferably employed. Among them, gas-phase process alumina (fumed alumina) which exhibits a sharp particle size distribution and excellent film-forming property, is more preferably employed. The gas-phase process alumina is produced by hydrolysis of gas-phase aluminum trichloride at a high temperature, and, as a result, is in the form of alumina particles having a high degree of purity. The alumina particles have a primary particle size in the order of nm and exhibit a very narrow particle size distribution (grain size distribution). The gas-phase process alumina has a cationic surface change. The use of the gas-phase alumina in the ink jet coating is disclosed in, for example, U.S. Pat. No. 5,171,626.

The alumina hydrate usable for the present invention is not limited to a specific type. In view of ink absorption and a film-forming property, the alumina hydrate is preferably selected from boemite and pseudo boemite. The methods of producing the alumina hydrate include a method in which aluminum isopropoxide is hydrolyzed with water (B. E. Yoldas, Amer. Ceram. Soc. Ball., 54,289 (1975) and a method disclosed in Japanese Unexamined Patent Publication No. 6-064918 in which an aluminum alkoxide is hydrolyzed.

The pigment usable for the third coating layer is selected from primary colloidal particles having an average primary particle size of 0.01 to 0.06 μm, preferably 0.02 to 0.05 μm and fine alumina and pseudo boemite particles having an average particle size of 0.01 to 1 μm, preferably 0.1 to 0.7 μm. Among them, the primary colloidal silica particles having a particle size of 0.01 to 0.06 μm have a high gloss. The primary colloidal silica particles include cation-modified colloidal silica particles. The fine alumina and pseudo boemite pigments exhibit excellent gloss, color density of recorded images, pigment aptitude and a fretting property to pigment ink.

The third coating layer optionally contains the same binder as used in the first and second coating layers as mentioned above in an appropriate amount, unless the binder affects the ink absorption of the third coating layer.

Preferable Embodiments of First and Second Coating Layers

In the ink jet recording materials of the present invention, the first coating layer preferably exhibits a pore size-distribution curve having at least one peak located in the range of from 0.1 to 10 μm of the pore size, and the second coating layer preferably exhibits a pore size-distribution curve having a peak located in the range of about 0.06 μm or less of the pore size. Alternatively, the first coating layer exhibits a pore size-distribution curve having at least one peak located in each of the ranges of 0.04 μm or less and from 0.2 to 5 μm of the pore size, and the second coating layer exhibits a pore size-distribution curve having a peak located in the range of about 0.04 μm or less of the pore size.

The pore size-distribution and the peaks in the distribution will be explained below.

The distribution of the pore size in the coating layers is determined as follows.

To avoid an influence of the substrate material on the determination, the coating layer to be measured is separated from the substrate material and is subjected to the determination, the pore size distribution is determined by using a micrometric pore size meter (trademark: Pore Sizer-9320, made by SHIMAZU SEISAKUSHO) in accordance with a mercury permeation method under pressure. The pore size by the mercury permeation method under pressure is calculated in accordance with the equation established under provision that the cross-sectional profiles of the pores are in the form of a circle, as follows.
R=−2γ·COS θ/P
wherein R represents a radius of pore (2R=pore size (diameter)), γ represents a surface tension of mercury, θ represents a contact angle of mercury, P represent a pressure applied to mercury.

The surface tension of mercury is 482,536 dyn/cm, the contact angle is established to 130 degrees, and the sizes (diameter) of pores are measured in a low pressure range (0 to 30 psia, measured pore radius range: 180 to 3 μm) and in a high pressure range (0 to 30000 psia, measured pore radius range: 3 to 0.003 μm) of the mercury pressure.

The pore size distribution is drawn in accordance with the above-mentioned principle, by gradually changing the pressure applied to mercury; measuring the volume of mercury percolated through the pores, namely a pore volume V of the coating layer; drawing a relationship curve between the pore size (2R) calculated in accordance with the above-mentioned equation and the pore volume V; and preparing a pore size distribution curve in a coordinate system having an ordinate axis relating to a differential coefficient dV/d (2R) established from the relationship curve and an abscissae axis relating to a pore size (diameter) 2R. Usually, the pore size distribution curve of each coating layer has one or more peaks.

The above-mentioned pore size distribution structures of the first and second coating layers are advantageous in that the above-mentioned functions of the first and second coating layers are further enhanced.

A First Coating Layer

When at least one peak appears in the range of pore size of from 0.1 to 10 μm in the pore size distribution curve of the first coating layer, the separation rate of the solvent in the ink droplets ejected from a printer head in the first coating layer greatly increases. Also, when a peak appears in the range of from substantially 0.06 μm or less in the pore size distribution curve of the second coating layer, the dye or pigment images fixed in the second coating layer exhibits a color density, and the images have a high uniformity, namely high roundness of dots. Namely, the above-mentioned second coating layer is substantially free from cracking.

In the ink jet recording material of the present invention, the first coating layer preferably has at least one peak in the range of pore size of from 0.1 to 10 μm in the pore size distribution curve. Also, for the purpose of enhancing the film-forming property and the ink absorption for the first coating layer, the polyvinyl alcohol is preferably cross-linked with a cross-linking compound. To enhance the film-forming property and the separation rate of the solvent component from the applied ink, of the second coating layer, the pore size distribution curve of the first coating layer preferably exhibit at least one peak in each of the pore size ranges of 0.04 μm or less and from 0.2 to 5 μm, more preferably in each of the pore size ranges of 0.03 μm or less and from 0.5 to 2 μm.

The above-mentioned first coating layer is, in fact, in a mat-like coating form. Also, the pigments contained in the first coating layer are different from colloidal pigments, are widly available in the trade, are cheap and are easily selected from various types of pigments. Further, the first coating layer can be coated in an afterweighing method and dried by a high temperature control and a high drying air flow, with a high efficiency. Furthermore, in the pore size distribution curve of the first coating layer, the peak appears in a rage pore size range of from 0.1 to 10 μm, and a change in capillary action force of the pores due to change in the water content of the coating layer is small, and thus substantially no curling phenomenon, due to a change in environmental conditions, occurs.

The pigments usable for the first coating layer are not limited to a special type of pigments as long as the pore size distribution curve of the first coating layer has at least one peak in the pore size range of from 0.1 to 10 μm. Preferably, pigment particles constituted from a plurality of primary particles having an average primary particle size of 0.003 to 0.04 μm and agglomerated with each other, and having an average particles size of 0.9 to 3 μm, are employed. To further enhance the ink absorption and the surface smoothness of the resultant ink jet recording material, more preferably the pigment particles constituted from a plurality of primary particles having an average primary particle size of 0.005 to 0.025 μm and agglomerated with each other, and having an average particle size of 1.0 to 2.5 μm are employed. There is no limitation to the type of pigment. Among the above-mentioned pigments, wet process silica particles are more preferably employed.

In the present invention, the average particle size of the pigment particles can be determined irrespective of the state of the pigment particles, namely a powder or a slurry, in such a manner that an aqueous dispersion containing 5% of pigment particles is prepared; the aqueous dispersion is agitated and dispersed by using a trade-available homomixer at a revolution rate of 5000 rpm for 30 minutes; the resultant pigment dispersion is subjected to electromicroscopic observation using an STM or a TEM, to take an electromicroscopic photograph at a magnification of 10,000 to 400,000; and on the photograph, the Martin sizes of the pigment particles located in an area of 5 cm×5 cm, are measured, and an average of the measured sizes is calculated. (“Fine Particle Handbook”, ASAKURA SHOTEN, page 52, 1991.) In the measurement carried out by the inventors of the present invention, when the pigment is in the state of a powder, the pigment particles mostly had a particle size of 1 μm or more, which is identical to the size shown in trade catalog for the pigment, and when the pigment is in the state of a slurry, the pigment particles mostly had a particle size of 1 μm or less, and the particle size greatly varies in response to agglomeration conditions of the particles. However, the measurement results can be substantially stabilized under the above-mentioned measurement conditions.

The polyvinyl alcohol usable for the first coating layer is preferably selected from silyl-modified polyvinyl alcohols and polyvinyl alcohols having a degree of polymerization of 2,000 or more, more preferably 2,500 to 5,000, by which an improved coating film strength can be easily obtained.

The mixing ratio of the pigment to the binder is preferably in the range of from 100/70 to 100/7 in which no problem occurs, more preferably 100/50 to 100/15 in view of balance between the ink absorption and the coating film strength, still more preferably 100/40 to 100/20.

To prevent the cracking of the coating film, the polyvinyl alcohol in the first coating layer is preferably cross-linked by a cross-linking compound.

The cross-linking compound for polyvinyl alcohol is preferably used in an amount of 0.001 to 10 parts by mass, more preferably 0.01 to 5 parts by mass, still more preferably 0.05 to 1 part by mass, based on 100 parts by mass of polyvinyl alcohol. If the amount of the cross-linking component in less than the above-mentioned lower limit, the resultant cross-linking effect may be insufficient. Also, if the amount of the cross-linking component is more than the above-mentioned upper limit, the resultant coating film may exhibit too high a rigidity and thus a problem, that the coating layer is easily broken down by bending, may occur.

The first coating layer optionally contains, in addition to the pigment and the binder, an additive comprising at least one member selected from dispersing agents, thickening agents, anti-foaming agents, coloring matters, antistatic agents and preservatives. In the first coating layer, a small amount of a dye is fixed due to absorption of the solvent in the applied ink, and thus, the first coating layer may contain a cationic compound for fixing the dye.

The cationic compound may be selected from, for example, 1) polyalkylenepolyamines, for example, polyethylenepolyamine and polypropylenepolyamine, and derivatives thereof; 2) acrylic resins having secondary amine groups, tertiary amine groups or quaternary ammonium groups; 3) polyvinyl amines, polyvinyl anidines and five membered ring amidines; 4) dicyan cationic resins, for example, dicyandiamide-formaldehyde polycondensation products; 5) polyamine cationic resins, for example, dicyandiamidediethylenetriamine polycondensation products; 6) epichlorohydrin-dimethylamine addition-polymerization products; 7) dimethyldiallylammonium chloride —SO₂ copolymerization products; 8) diallylamine —SO₂ copolymerization products; 9) dimethyldiallylammonium chloride polymerization products; 10) alkylamine salt polymerization products; 11) dialkylaminoethyl (meth)acrylate quaternary salt polymerization products; 12) acrylamide-diallylamine salt copolymerization products; 13) aluminum salts, for example, aluminum polychlorides, aluminum polyacetates and aluminum polylactates; 14) copolymerization products of diallylamine of hydrochloric salt with diallylmethylammonium chloride; and 15) zirconium salts, for example, zirconium carbonate, which are available in trade. The cationic compound is preferably employed in an amount of 1 to 30 parts by mass, more preferably 2 to 15 parts by mass, per 100 parts by mass of the pigment.

There is no limitation to the amount of the first coating layer. Usually, the amount of the first coating layer is preferably controlled to 1 to 30 g/m², more preferably 3 to 15 g/m². If the amount of the first coating layer is too small, the resultant ink receiving layer may exhibit an insufficient ink absorption. If it is too large, the pore size distribution of the resultant second coating layer may not be controlled.

B Second Coating Layer

The second coating layer to be formed on the first coating layer comprises the above-mentioned pigment and a binder containing at least polyvinyl alcohol. Particularly, in order that the resultant second coating layer exhibits a pore size distribution curve having a peak in the pore size range of 0.06 μm or less and thus has a high resistance to crack generation, the second coating layer contains an appropriate cross-linking agent for polyvinyl alcohol.

The amount of the cross-linking compound for polyvinyl alcohol is preferably 0.001 to 10 parts by mass, more preferably 0.01 to 5 parts by mass, still more preferably 0.05 to 1 part by mass, per 100 parts by mass of polyvinyl alcohol. If the amount of the cross-linking component is too small, the desired cross-linking effect may be difficult to obtain, and if it is too large, a problem, that the resultant coating layer is too rigid and is easily broken when heated, may occur.

The second coating layer is controlled so that the pore size distribution curve has a peak located in the pore size range of substantially 0.06 μm or less. In order that the dye or pigment in the ink is rapidly separated from the solvent and forms images having a high color density, the peak in the pore size distribution curve is preferably located in the pore size range of 0.04 μm or less, more preferably 0.025 μm or less. When the peak in the pore size distribution curve is located in the pore size range of substantially 0.06 μm or less, the pores formed in the coating layer due to a small number of cracks or dust (for example, total number of cracks and dust particles in an area of 10 cm² is 20 or less), are substantially negligible in view of the total ink absorption capacity of all the coating layers.

There is no limitation to the particle size of the pigment as long as the peak in the pore size distribution curve is located in the pore size range of 0.06 μm or less.

Preferably, the pigment particles are selected from those constituted from a plurality of primary particles having an average primary particle size of 0.003 to 0.04 μm and agglomerating with each other to form secondary particles having an average secondary particle size of 0.7 μm or less. In order that the dye or pigment in the ink can be easily fixed in the second coating layer and high ink absorption rate, color density and gloss can be obtained, pigment particles constituted from a plurality of primary particles having an average primary particle size of 0.005 to 0.020 μm and agglomerating with each other, and having an average particle size of 0.5 μm or less are more preferably employed. Still more preferably, the pigment particles are constituted from a plurality of mutually agglomerated primary particles having an average primary particle size of 0.007 to 0.013 μm and have an average particle size of 0.2 μm or less.

There is no specific limitation to the type of the pigment. Preferably, the pigment is selected from silica, alumina and pseudo boemite. Among them, a dry process silica having high ink absorption and film-forming property is more preferable. Generally, pigment particles having an average particle size of 0.7 μm or less are not available in trade and can be prepared by, for example, applying a large force by a mechanical means in accordance with a breaking down method (in which a bulk material is finely pulverized. As the mechanical means, a supersonic homogenizer, a pressurizing homogenizer, a liquid flow-impingement homogenizer, a high speed rotation mill, a roller mill, a container-driving medium mill, a medium agitation mill, a jet mill, a mortar, a grinding machine in which a material to be ground in a bowl-shaped container is ground and kneaded with a pestle-formed agitation rod, and a sand grinder. To decrease the particle size, classification and pulverization operations must be repeatedly applied to the pigment material.

To enhance the fixing property of the second coating layer for the dye or pigment in the ink, a cationic compound which is usable for the first coating layer may be contained in the second coating layer.

When the dry process silica is used as a pigment for the second coating layer, silica-cationic compound agglomeration particles, prepared by mixing the dry process silica with the cationic compound to cause the mixture to be agglomerate, and pulverizing the resultant silica-cationic compound agglomerate particles into a particle size of 0.7 μm or less, preferably 0.05 to 0.5 μm, are preferably employed. In this case, the cationic compound may be selected from the above-mentioned group of cationic compounds. In consideration of dye-fixing property and dispersion property of the resultant agglomerate particles, 1) five-membered ring amidines and 2) aluminum salts, for example, aluminum polychloride, aluminum polyacetate and aluminum polylactate, are preferably employed.

The polyvinyl alcohol for the second coating layer is preferably selected from those having a polymerization degree of 2000 or more, more preferably of 3000 to 5000, which have a good balance between film-forming property and ink absorption. These polyvinyl alcohols are preferably cross-linked with the above-mentioned cross-linking compounds.

There is no specific limitation to the mass ratio of the pigment to the binder contained in the second coating layer, unless the ink absorption is obstructed. Preferably, the mass ratio is in the range of from 100/40 to 100/10, more preferably from 100/22 to 100/2 in which range the balance between the ink absorption and the coating film strength is enhanced.

The second coating layer optionally contains, in addition to the pigment and binder, an additive containing at least one member selected from dispersing agents, thickening agents, anti-foaming agents, coloring matters, anti-static agents, and preservatives. There is no specific limitation to the amount of the second coating layer. Usually, the amount of the second coating layer is controlled in the range of from 2 to 40 g/m², preferably from 3 to 15 g/m². If the amount is too small, the resultant second coating layer may exhibit an insufficient dye-fixing property, and if it is too large, the effect of the second coating layer may be saturated.

The pore volume of the second coating layer is preferably controlled in the range of from 0.3 to 1 ml/g, more preferably from 0.5 to 0.8 ml/g. If the pore volume is too small, the resultant second coating layer may exhibit an insufficient ink absorption and if it is too large, the resultant second coating layer may have an insufficient transparency and the color density of images may be decreased.

To obtain an ink jet recording material having a high gloss, a method in which the second coating layer which is in a wetted condition is brought into contact with a heated mirror-finished drum surface under pressure and dried on the drum surface, namely a cast method, is advantageous. To easily separate the second coating layer from the mirror-finished drum surface, a release agent available in trade, for example, stearic amide, polyethylene wax, or ammonium oleate, may be appropriately contained in the second coating layer. A cationic release agent is preferably employed. There is no limitation to the amount of the release agent. Usually, the release agent is employed in an amount of 0.5 to 10 parts by mass per 100 parts of the pigment.

In order to separate, in function, the first and second coating layers from each other and to allow the first coating layer to absorb the solvent component from the ink at a high absorption rate, and the second coating layer to fix the dye or pigment in the ink at a high fixing rate, the mass ratio of the first coating layer to the second coating layer is preferably established in the range of from 100/300 to 100/30, more preferably from 100/100 to 100/50.

Preferable Embodiment of Third Coating Layer

The third coating layer forms a recording surface of the ink jet recording material of the present invention and imparts high gloss, a pigment aptitude and a fretting property to the pigment ink to the recording surface.

The third coating layer is preferably formed by a method in which the third coating layer, which is in a wetted condition, is brought into contact with a mirror-finished heating drum under pressive and dried, namely, a cast method. To make the third coating layer to be easily separated from the mirror-finished drum, the above-mentioned release agents available in trade is appropriately contained in the third coating layer. The amount of the release agent is preferably in the range of from 0.5 to 10 parts by mass, per 100 parts by mass of the pigment.

The amount of the third coating layer is preferably in the range of from 0.1 to 10 g/m², more preferably from 0.5 to 2 g/m². If the coating amount is too small, the resultant coating layer is too thin and when exposed to light, an interference color may be easily generated, and if the coating amount is too large, the ink absorption rate may be greatly decreased.

In the ink receiving layer of the ink jet recording material of the present invention, the pigment contained in the first coating layer preferably comprises wet process silica fine particles having an average primary particle size of 0.003 to 0.04 μm and an average secondary particle size of 0.7 to 3 μm; the second coating layer preferably contains at least one member selected from gas phase process silica and mesoporous silica fine particle pigment, secondary particle silica pigment having a specific surface area of 100 to 400 m²/g determined in accordance with a nitrogen absorption method, an average secondary particle size of 20 to 300 nm and a pore volume of 0.5 to 2.0 ml/g, and alumina and alumina hydrate fine particle pigment having an average particle size of 0.01 to 1 μm; and the third coating layer preferably contains at least one member selected from alumina and pseudo boemite fine particle pigments having an average particle size of 0.1 to 0.7 μm.

Other Coating Layers

The ink jet recording material of the present invention optionally has a back coating layer formed on the back surface of the substrate material to impart a photograph-like hand to the recording material and to control a curling phenomenon of the recording material. There is no specific limitation to the composition of the back coating layer. The back coating layer may contain at least one member selected from mixtures of fine particulate pigments with binders (for example, a mixture of a colloidal silica with an acrylic resin emulsion), and hydropholic and hydrophilic adhesives (for example, polyvinyl alcohol) and laminates. To impart the photograph-like hand to the recording material, a lamination of the recording material with polyethylene is most effective. Also, the back coating layer may be provided for the purpose of improving a curl-preventing property and a transportation property of the recording material.

In the ink jet recording material of the present invention, a further coating layer may be arranged between the substrate material and the first coating layer to improve the adhesion of the first coating layer to the substrate material and to further enhance the ink absorption of the ink receiving layer.

Coating Procedure

The coating apparatus for the first, second and third coating layers may be selected from various conventional coating apparatus, for example, a blade coater, an airknife coater, a roll coater, a bar coater, a gravure coater, a rod blade coater, a lip coater, a curtain coater and a die coater.

In the case where two or more layers are coated, a wet on wet process in which a upper coating layer is coated on an under coating layer while the under coating layer is still in a wetted condition, is preferably employed.

Another Embodiment (1) of Ink Receiving Layer

In another preferable embodiment of the ink receiving layer of the ink jet recording material of the present invention, the first coating layer comprises pigment particles constituted from primary particles having an average primary particle size of 0.003 to 0.04 μm, more preferably 0.005 to 0.025 μm and agglomerating with each other to form secondary particles having an average secondary particle size of 0.7 to 3 μm, more preferably 1.0 to 2.5 μm, preferably comprising, as a principal component, wet process silica, and a binder comprising polyvinyl alcohol (preferably having a polymerization degree of 2000 or more, more preferably 2500 to 5000, or a modified polyvinyl alcohol (for example, a silyl-modified polyvinyl alcohol).

The pigment contained in the first coating layer is preferably selected from silica, alumina, alumina hydrate, alumina silicate and calcium carbonate. Among them, a wet process silica is more preferably employed.

Pigments having a particle size of 1 μm or more are available in the trade. Another pigment having a particle size of 1 μm or less can be produced by applying a large force to the conventional pigment particles by a mechanical means in accordance with a breakdown method in which the bulky pigment material is finely pulverized. The mechanical means include a supersonic homogenizer, pressurizing homogenizer, liquid flow-impingement homogenizer, a high solution mill, a roller mill, a container driving medium mill, a medium agitation mill, a jet mill, a mortar, grinding machine in which a material to be pulverized in a bowl-shaped container is ground and kneaded with a pestle-formed agitation rod, and a sand grinder.

Also, the pigment contained in the second coating layer preferably comprises at least one member selected from gas phase process silica, mesoporous silica, dispersions of silica secondary particles having a specific surface area of 100 to 400 m²/g determined by a nitrogen absorption method, an average secondary particle size of 20 to 300 nm and a pore volume of 0.5 to 2.0 ml/g, and alumina and alumina hydrate.

The dispersion of silica secondary particles can be produced by adding an alkali to a silica seed liquid in which the silica particles are dispersed in colloidal state and then further mixing, little by little, a feed liquid comprising at least one member selected from aqueous activated silicic acid solution and alkoxysilanes into the alkali-added silica seed liquid to cause the fine silica particles to grow.

The above-mentioned dispersion of silica secondary particles contained in the second coating layer comprises, as a principal component, silica pigment particles comprising primary particles having an average particle size of 0.003 to 0.4 μm and agglomerating with each other to form secondary particles having an average secondary particle size of 0.7 μm or less, preferably 0.05 to 0.5 μm.

The above-mentioned alumina is preferably a gas-phase process alumina. Further, the silica pigment contained in the second coating layer may be fine particles of a silica-cationic compound agglomerate prepared by mixing a cationic compound into a silica dispersion and pulverizing and dispersing the resultant particles of a silica-cationic compound agglomerate into fine particles of the silica-cationic compound agglomerate having a particle size of 1.0 μm or less.

The binder contained in the second coating layer preferably comprises a polyvinyl alcohol having a polymerization degree of 2000 or more, more preferably 3000 to 5000 and/or a cross-linked polyvinyl alcohol with a cross-linking compound. The cross-linking compound is preferably selected from boron-containing compounds, for example, borax and boric acid.

In the embodiment having the constitution as mentioned above, the second coating layer preferably has a pore volume of 0.3 to 1 ml/g.

The second coating layer is preferably formed by bringing a coating layer, which is kept in a wetted state, into contact with a heated mirror-finished drum under pressure, and drying the casted layer.

In the above-mentioned embodiment, the third coating layer is the same as mentioned above.

Another Embodiment (2) of an Ink Receiving Layer

In another preferable embodiment (2) of the ink receiving layer, the binder contained in the second coating layer is a thickened or a cross-linked binder.

In this embodiment (2), the thickening or cross-linking procedure for the binder in the second coating layer is preferably applied simultaneously with the application of a binder-containing coating liquid for the second coating layer on the second coating layer, or during drying procedure applied to the coated coating liquid layer and before the applied coating liquid layer exhibits a falling rate of drying. Also, the thickened or cross-linked binder preferably contains a cross-linked polyvinyl alcohol with a cross-linking compound. The cross-linking compound is preferably selected from boron-containing compounds, for example, borax and boric acid. Also, the thickened or cross-linked binder preferably contains a hydrophilic resin hydrogelled by electron beam irradiation. The polyvinyl alcohol contained in the second coating layer preferably has a polymerization degree of 2000 or more, more preferably 3000 to 5000.

The second coating layer in this embodiment (2) preferably has a pore volume of 0.3 to 1 ml/g.

In this embodiment (2), the pigment contained in the first coating layer preferably comprises, as a principal component, pigment particles having an average secondary particle size of 0.7 to 3 μm and constituted from primary particles having an average primary particle size of 0.003 to 0.04 μm and agglomerating with each other to form the secondary particles, and the pigment contained in the second coating layer preferably comprises pigment particles having an average secondary particle size of 0.7 μm or less and constituted from primary particles having an average primary particle size of 0.003 to 0.04 μm and agglomerating with each other to form secondary particles.

The pigment in the second coating layer is preferably selected from silica, alumina, and alumina hydrate, and the alumina is preferably a gas phase process alumina.

In this embodiment (2), the pigments for the first and second coating layers respectively comprise, as a principal component, silica. Preferably, the silica for the first coating layer is a wet process silica and silica for the second coating layer is a gas phase process silica.

The silica pigment contained in the second coating layer may be contained in agglomerate particles formed from silica with a cationic compound, and the silica-cationic compound agglomerate particles preferably have an average particle size of 1.0 μm or less.

Further, the second coating layer in this embodiment (2) has a smooth surface formed by bringing second coating layer which is in wetted condition into contact with a heated mirror-finished drum under pressure and drying the coating layer.

In this embodiment (2), the third coating layer is the same as mentioned above.

In the embodiment (2) of the present invention, the pore size distribution curve of the first coating layer preferably has at least one peak located in the pore size range of from 0.1 to 10 μm and, in this case, the pore size distribution curve of the second coating layer preferably has a peak located in the pore size range of 0.06 μm or less.

Namely, the first and second coating layers are preferably controlled so that the second coating layer containing the fine pigment particles is formed, without cracking, on the first coating layer. Generally, the surface of the first coating layer exhibiting a satisfactory pore size distribution curve has a certain roughness and the pore size of the first coating layer is large. When a coating liquid containing extremely fine pigment particles for the second coating liquid is coated on the first coating liquid, the extremely fine pigment particles move down into the concave portions, and thus the desired coating film may not be formed. As a result of the extensive study of the inventors of the present invention, it was found that an application of a thickening or cross-linking treatment to the coating liquid for the second coating layer at a stage at which the coating liquid for the second coating liquid is applied onto the first coating layer or during the drying step for the applied coating liquid layer and before the coating liquid layer exhibits a failing rate of drying, is advantageous to form a porous continuous coating film (the second coating layer), comprising the extremely fine pigment particles, without cracking. In the second coating layer, air bubbles and fine dusts affect on the quality of the resultant recording material, and thus the coating procedure for the second coating layer is preferably carried out by a weighing system. Also, to prevent cracking, the second coating layer is dried at a lower drying rate than that for the first coating layer.

In the case where the pore size distribution curve for the second coating layer has a peak located in the pore size range of substantially 0.06 μm or less, the change in capillary force due to a change in water content is large and thus the resultant recording material is naturally caused to curl. However, in view of the constitution of the recording material of the present invention, basically, the second coating layer has no problem as long as the dye or pigment in the ink can be fixed in the second coating layer, and thus the change in capillary force due to a change in water content of the second coating layer is small, and thus curling phenomenon of the recording material due to environment can be sufficiently controlled.

There is no specific limitation to the method of forming the second coating layer as long as the thickening or cross-linking treatment can be applied to the coating liquid for the second coating layer simultaneously with the application of the coating liquid for the second coating layer or during the drying of the applied coating liquid and before the coating liquid exhibits a falling rate of drying. For example, the coating liquid for the second coating layer contains a hydrophilic resin capable of forming a hydrogel upon irradiation for electron beam and immediate after the application of the coating liquid or during the drying of the applied coating liquid layer and before the coating liquid exhibits a falling rate of drying, the thickening (hydrogelation) treatment is applied to the coating liquid by irradiating an electron beam onto the coating liquid layer. In another example, the coating liquid for the second coating layer contains polyvinyl alcohol, and immediately after the application of the coating liquid, or during the drying of the applied coating liquid and before the coating liquid exhibits a falling rate of drying, the coating liquid is thickened or cross-linked with a cross-linking compound for the polyvinyl alcohol.

The hydrogenation by irradiation with an electron beam will be explained in detail below.

The ink absorption of the second coating layer increases with increase in the pore volume. Also, the increase in pore volume causes the shrinkage of the second coating layer to increase due to capillary force generated in the drying step of the applied coating liquid layer. Therefore, when a conventional coating method is applied, the second coating layer may be defective due to cracking of the coating layer. This problem can be solved by irradiating an electron beam onto the coating liquid layer to hydrogenate the hydrophilic resin in the coating liquid layer.

The hydrophilic resin capable of hydrogallating by irradiation with an electron beam includes, for example, perfactly saponified polyvinyl alcohol, partially saponified polyvinyl alcohols, polyethyleneoxide, polyalkyleneoxide, polyvinyl pyrrolidone, water-soluble polyvinyl acetal, poly-N-vinyl acetamide, polyacrylamide, polyacryloyl morpholine, polylhydroxyalkyl acrylate, polyacrylic acid, hydroxyethyl cellulose, methyl cellulose, hydroxypropylmethyl cellulose, hydroxypropyl cellulose, gelatin, casein and water-soluble derivatives thereof. When the resin is contained in the second coating layer, the resin can be hydrogenated by irradiating an electron beam onto the coating liquid layer. Among the above-mentioned hydrophilic resins, polyvinyl alcohol having a good compatibility with the fine pigment is preferably employed.

The term “hydrogel” is a state of a polymeric substance which is swollen, with a medium comprising, as a principal component, water, in a three-dimensional network structure and has substantially no fluidability. The electron beam cross-linking reaction for the coating layer of the present invention is initiated by withdrawing hydrogen atoms from the polymeric molecules, and no specific functional groups are cross-linked.

The optimum molecular weight of the hydrophilic resins usable for the present invention is variable in response to the type of the resins and thus cannot be generally indicated. If the molecular weight is too large, the resultant coating liquid is easily gellated when mixed with the fine pigment particles, and even when not gellated, the resultant coating liquid exhibits a high viscosity and, therefore, a problem relating to coating property of the coating liquid may occur. Also, if the molecular weight is too low, the hydrogel produced by the electron beam irradiation to the hydrophilic resin exhibit an insufficient gel strength and, thus, cracking of the resultant coating layer occurs after drying, and the advantage of the present invention may not be sufficiently obtained. Accordingly, the preferable molecular weight of typical hydrophilic resins is in the range of from about 10,000 to 5,000,000, more preferably 50,000 to 1,000,000.

In the mixture of the fine pigment particles which are a principal component of the second coating layer with the hydrophilic resin capable of forming a hydrogel by electron beam irradiation, the content of the hydrophilic resin is preferably 1 to 100 parts by mass per 100 parts by mass of the fine pigment particles.

As the ink jet recording material of the present invention is used to record thereon images by receiving the ink in pores formed inside and outside of the fine pigment particles, the content of the hydrophilic resin is preferably controlled to a minimum in view of ink absorption. Also, as the hydrophilic resin causes the apparent particle size of the fine pigment particle contained in the ink receiving layer to increase, the content of the hydrophilic resin is preferably controlled to as small as possible, in view of the transparency of the resultant ink receiving layer, unless the cracking of the second coating layer occurs. For the reasons mentioned above, the hydrophilic resin is preferably contained in an amount of 3 to 30 parts by mass, more preferably 5 to 25 parts by mass, per 100 parts by mass of the fine pigment particles.

In the present invention, the electron beam can be irradiated by a scanning method, a curtain-beam method and a broad-beam method. In the irradiation of the electron beam, the acceleration voltage is preferably controlled in the range of from 50 to 30 kV, and the radiation absorbed dose of the electron beam is preferably controlled in the range of from 1 to 200 kGy. If the absorbed dose is less than 1 kGy, the coating layer may not be sufficiently gellated, and if it is more than 200 kGy, the substrate material and coating layers may be degraded and the color may change. When the coating liquid for the second coating layer contains polyvinyl alcohol, and after the application of the coating liquid or during the drying of the applied coating liquid layer and before the coating liquid layer exhibits a falling rate of drying, a cross-linking compound for polyvinyl alcohol is added to the coating liquid layer, to cross-link the polyvinyl alcohol in the coating liquid, the cracking of the second coating layer can be controlled. In the coating liquid for the second coating layer, the content of the cross-linking compound for polyvinyl alcohol is preferably controlled in the range of from 0.001 to 10 parts by mass, more preferably 0.01 to 5 parts by mass, still more preferably 0.05 to 1 part by mass, per 100 parts by mass of polyvinyl alcohol. If the cross-linking compound content is too small, the cross-linking effect may be insufficient and if it is too large, a problem that the resultant coating layer is too rigid and easily broken by bending, may occur.

The second coating layer is preferably controlled so that the pore size distribution curve exhibits a peak located in the pore size range of from substantially 0.06 μm or less, and to promote the separation of the dye from the ink and to record dye images having a high color density, the peak in the pore size distribution curve is more preferably located in the pore size range of 0.04 μm or less, still more preferably 0.025 μm or less. In the present invention, when the peak in the pore size distribution curve is located in the pore size range of 0.06 μm or less, the pores formed by cracking of the coating layer or the adhering of dust to the coating layer, (for example, the total number of the crackings and dust particles appearing in an area of 10 cm² is 20 or less), are substantially negligible in view of the total ink absorption capacity of the coating layer.

Ink Jet Recording Ink

The ink usable for the ink jet recording material of the present invention comprises, as indispensable components, a coloring matter for forming images and a liquid medium for dissolving or dispersing the coloring matter, and, as optional components, a dispersing agent, a surfactant, a viscosity-regulating agent, a specific resistance-controlling agent, a pH-regulating agent, a mildewproofing agent and/or a stabilizer for the solution or the dispersion of the recording agent.

The dye and pigment usable for the recording ink are not limited to specific dyes and pigments and include dried dyes, acid dyes, basic dyes, reactive dyes, edible coloring matters, disperse dyes, oil dyes and pigments which may be well-known ones. The content of the dye or pigment in the ink is established in response to the type of medium of the ink and the properties necessary to the ink. In ink for the recording material of the present invention, the medium is contained in a content of 0.1 to 20% by mass which is identical to that of conventional inks.

The medium for the ink usable for the recording material of the present invention includes water and water-soluble organic solvents, for example, alkyl alcohols having 1 to 4 carbon atoms, for example, methyl alcohol, ethyl alcohol, n-propyl alcohol, isopropyl alcohol, n-butyl alcohol an disobutyl alcohol; ketone and ketone alcohols, for example, acetone and diacetone alcohol; polyalkylene glycols, for example, polyethylene glycol, and polypropylene glycol; alkylene glycols containing an alkylene group having 2 to 6 carbon atoms, for example, ethylene glycol, propylene glycol, 1,2-hexanediol, butylene glycol, triethylene glycol, 2-pyrrolidone, thiodiglycol, hexylene glycol and diethylene glycol; amides, for example, dimethylformamide; ethers, for example, tetrahydrofuran; polyhydric alcohols and lower alkyl ethers thereof, for example, glycerol, ethylene glycol methylether, diethylene glycol methyl (ethyl) ether, and triethylene glycol monomethyl ether.

The pigment ink composition usable for the ink jet recording material of the present invention preferably comprises, as a cationic resin, polyethyleneimine having a weight average molecular weight of 100 to 5000 in a content of 0.1 to 2%. The pigment ink optionally contains fine polymer particles having an average particle size of 20 to 70 nm or 100 to 150 nm, a glass transition temperature (Tg) of 10° C. or less, a lowest film-forming temperature (MFT) of 50° C. or less and a weight average molecular weight of 500,000 or less.

### EXAMPLES

The ink jet recording material of the present invention will be further illustrated by the following examples.

### Example 1

(1) A substrate material consisting of a coated paper sheet (trademark; OK COAT, basis mass: 127.9 g/m², made by OJI PAPER CO. LTD.) was employed.

(2) A coating liquid (1) for first coating layer was prepared as shown below.

Coating Liquid (1) for First Coating Layer

A aqueous dispersion having a concentration of 15% by mass was prepared from 100 parts by mass of a wet process silica (trademark: FINESIL F-80, average primary particle size; about 0.009 μm, average secondary particle size: 1.5 μm, made by TOKUYAMA K.K.), 30 parts by mass of a binder consisting of polyvinyl alcohol (trademark: PVA-124, made by KURARAY K.K.) and 2 parts by mass of a cationic compound consisting of a diallyldimethyl ammonium chloride-acrylamide copolymer (trademark: PAS-J-81, made by NITTOBO K.K.).

(3) A coating liquid (2) for second coating layer was prepared as follows.

Coating Liquid (2) for Second Coating Layer

An aqueous dispersion having a concentration of 8% by mass was prepared from a mixture of 100 parts by mass of silica fine particles (A) with 20 parts by mass of a binder consisting of polyvinyl alcohol (trademark: PVA-135, polymerization degree: 3500, saponification degree: 98.5%, made by KURARAY K.K.

The above-mentioned silica fine particles (A) was prepared by the following procedures.

[Silica Fine Particles (A)]

Dry process silica particles (trademark: AEROSIL A 300, average primary particle size: about 0.008 μm, average secondary particle size: 1.0 μm, made by NIHON AEROSIL K.K.) were dispersed in water and subjected to a pulverizing and procedure in which a combination of a pulverizing step using a sand grinder with a further pulverizing step using a pressure-applying homogenizer was repeatedly applied to the dispersion until the average particle size of the silica particle reached 0.08 μm, to provide an aqueous dispersion of the silica particles in a concentration of 10% by mass.

Into the 10% by mass aqueous silica dispersion, 10 parts by mass of a cationic compound having a five-membered ring amidine structure (trademark: SC-700, molecular weight: 300,000, made by HAIMO K.K.), and the resultant dispersion was subjected to a pulverizing treatment in which a combination of a pulverizing step using a sand grinder with a further pulverizing step using a pressure-applying homogenizer was repeatedly applied to the dispersion until the average particle size of the silica-cationic compound agglomerate particles reached to 0.15 μm, to provide an aqueous dispersion having a concentration of 10% by mass.

(4) A coating liquid (3) for third coating layer was prepared as follows.

Coating Liquid (3) for Third Coating Layer

An aqueous dispersion for the coating liquid (3) having a concentration of 5% by mass was prepared from a mixture of 100 parts by mass of alumina fine particles B with 5 parts by mass of a binder consisting of polyvinyl alcohol (trademark: PVA-135, polymerization degree: 3500, saponification degree: 98.5%, made by KURARAY K.K.) and 3 parts by mass of stearic amide.

The alumina fine particles (B) were prepared by the following procedures.

High purity alumina particles (trademark: AKP-G015, type: γ-crystalline aluminum oxide, average primary particle size: about 0.1 μm average secondary particle size: 3.0 μm, made by SUMITOMO KAGAKUKOGYO K.K.) was subjected to a pulverizing procedure in which a combination of a pulverizing step using a sand grinder with a further pulverizing step using a high-speed liquid-flow-clashing homogenizer was repeatedly applied to the dispersion until the average particle size of the alumina particles reached 0.25 μm, to provide an aqueous alumina dispersion having a concentration of 10% by mass.

(5) The coating liquid (1) for first coating layer was coated in a dry coating amount of 10 g/m² on a surface of the substrate material (coated paper sheet) and dried to form a first coating layer. On the first coating layer, a second coating layer was formed in such a manner that on the first coating layer, an aqueous solution of 3% by mass of borax was coated in a dry coating amount of 0.15 g/m² and then the coating liquid (2) for second coating layer was further coated in a dry coating amount of 5 g/m² by a wet-on-wet method in which an undercoat liquid is coated and, before the undercoat liquid layer is dried, an uppercoat liquid is coated on the wetted undercoat layer when two or more coating layers are formed, and dried, to form the second coating layer.

On the second coating layer, the coating liquid (3) for third coating layer was coated in a dry coating amount of 1 g/m² and while the coating liquid (3) layer was still kept in wetted condition, the wetted coating liquid (3) layer was brought into contact with a mirror-finished drum having a surface temperature of 100° C. under pressure and dried. Then the resultant dried third coating layer was released from the drum. An ink jet coating material was obtained.

### Example 2

An ink jet recording material was produced by the same procedures as in Example 1, with the following exceptions.

The coating liquid (3) for third coating layer was replaced by the coating liquid (4) prepared as follows.

Coating Liquid (4) for Third Coating Layer

An aqueous liquid for coating liquid (4) having a concentration of 5% by mass was prepared from 100 parts by solid mass of primary colloidal silica dispersion (trademark: ST-OL, average particle size; 0.045 μm, made by NISSAN KAGAKU K.K.) mixed with one part by mass of a binder consisting of a silyl-modified polyvinyl alcohol (trademark: R-1130, polymerization degree: 1800, made by KURARAY K.K.) and 5 parts by mass of ammonium oleate.

### Example 3

An ink jet recording material was produced by the same procedures as in Example 2, with the following exceptions.

In the formation of the second coating layer, while the coating liquid (2) layer applied on the first coating layer was still kept in wetted condition, the coating liquid (2) layer was brought into contact with a mirror-finished drum having a surface temperature of 90° C. under pressure and dried. Then the resultant second coating layer was released from the drum.

### Example 4

An ink jet recording material was produced by the same procedures as in Example 1, with the following exceptions.

In the coating liquid (1) for the first coating layer, the wet process silica (trademark: Finesil F80) was replaced by another wet process silica (trademark: Finesil X-45, average primary particle size: 0.01 μm, average secondary particle size: 4.5 μm, made by TOKUYAMA K.K.

### Example 5

An ink jet recording material was produced by the same procedures as in Example 1, with the following exceptions.

In the coating liquid (1) for first coating layer, the silica used in Example 1 was replaced by another wet process silica having an average particle size of 3 μm (trademark: MIZUKASIL P-78A, average primary particle size: about 0.007 μm, made by MIZUSAWA KAGAKUKOGYO K.K.).

### Example 6

An ink jet recording material was produced by the same procedures as in Example 1, with the following exceptions.

In the coating liquid (1) for the first coating layer, the wet process silica used in Example 1 was replaced by another wet process silica (trademark: Finesil F-80, average primary particle size: about 0.009 μm, average secondary particle size: 1.5 μm, made by TOKUYAMA K.K., and the amount of the binder was changed from 40 parts by mass to 30 parts by mass.

### Example 7

An ink jet recording material was produced by the same procedures as in Example 6, with the following exceptions.

The silica fine particles (A) used in the coating liquid (2) for the second coating layer of Example 6 was replaced by the alumina fine particles (B).

### Example 8

An ink jet recording material was produced by the same procedures as in Example 6, with the following exceptions.

In place of the silica fine particles (A) used in the coating liquid (2) for the second coating layer of Example 6, a pseudo beomite having an average secondary particle size of about 0.4 μm (trademark: AS-3, average primary particle size: about 0.05 μm, made by SHOKUBAI KASEI K.K.) was employed.

### Example 9

An ink jet recording material was produced by the same procedures as in Example 6, with the following exceptions.

In the formation of the second coating layer, while the coating liquid (2) layer applied on the first coating layer was still kept in wetted condition, the coating liquid (2) layer was brought into contact with a mirror-finished drum having a surface temperature of 90° C. under pressure and dried. Then the resultant second coating layer was released from the drum.

Also, the coating liquid (3) for third coating layer consisted of an aqueous dispersion having a concentration of 10% by mass prepared from 100 parts by mass of gas phase porous aluminum oxide fine particles (trademark: PG-003, average primary particle size: 20 nm, average secondary particle size: 100 nm, crystal structure: α/δ/γ=3/1/1, made by CABOT CO.) mixed with 10 parts by mass of stearic amide.

### Comparative Example 1

An ink jet recording material was produced only by coating a surface of the same substrate material as that used in Example 1 with the coating liquid (1) for the first coating layer in a dry coating amount of 15 g/m², and drying the coated coating liquid (1) layer.

### Comparative Example 2

An ink jet recording material was produced only by coating the same substrate material as in Example 1 with an aqueous solution of 3% by mass of borax in a dry coating amount of 0.2 g/m² and further with the coating liquid (2) for the second coating layer of Example 1 in a dry coating amount of 15 g/m², by the wet-on-wet method, and drying the coated liquid layers.

### Comparative Example 3

An ink jet recording material was produced by the same procedures as in Comparative Example 2, with the following exception.

The 3% aqueous borax solution was not employed in combination with the coating liquid (2) for the second coating layer.

### Comparative Example 4

An ink jet recording material was produced by the same procedures as in Example 1, with the following exceptions.

The wet process silica (Finesil F-80) contained in the coating liquid (1) for the first coating layer was replaced by another wet process silica (trademark: Finesil X-45, average primary particle size: 0.01 μm, average secondary particle size: 4.5 μm, made by TOKUYAMA K.K.), the 3% aqueous borax solution was not employed in combination with the coating liquid (2) for the second coating layer; and the third coating layer was omitted.

### Comparative Example 5

An ink jet recording material was produced by the same procedures as in Example 1, with the following exceptions.

The coating liquid (1) for the first coating layer was replaced by a coating liquid (5) as shown below, the coating liquid (2) for the second coating layer was replaced by a coating liquid (6) as illustrated below, and no third coating layer was coated.

Coating Liquid (5)

A aqueous dispersion having a concentration of 15% by mass was prepared from 100 parts by mass of a wet process silica (trademark: FINESIL X-45, average primary particle size: about 0.01 μm, average secondary particle size: 4.5 μm, made by TOKUYAMA K.K.)., 30 parts by mass of a binder consisting of polyvinyl alcohol (trademark: PVA-117, made by KURARAY K.K.) and 15 parts by mass of a cationic compound (trademark: SR-1001, made by SUMITOMO KAGAKUKOGYO K.K.).

Coating Liquid (6)

An aqueous dispersion having a concentration of 15% by mass was prepared from a mixture of 100 parts by mass of primary colloidal silica particles (trademark: ST-ZL, made by NISSAN KAGAKU K.K.) with 13 parts by mass of a binder consisting of a silyl-modified polyvinyl alcohol (trademark: R-2105, polymerization degree: 500, made by KURARAY K.K.).

Production of Ink Jet Recording Material

The coating liquid (5) was coated in a dry coating amount of 10 g/m² on a surface of the substrate material (coated paper sheet) and dried to form a first coating layer. On the first coating layer, a coating liquid (6) was coated in a dry coating amount of 5 g/m² and dried to form a second coating layer. A comparative ink jet recording material was obtained.

### Comparative Example 7

An ink jet recording material was produced by the same procedures as in Example 1, with the following exceptions.

The first coating layer was formed from the above-mentioned coating liquid (2), the second coating layer was formed from the coating liquid for the first coating layer used in Comparative Example 4, and the third coating layer was omitted.

### Comparative Example 8

An ink jet recording material was produced by the same procedures as in Example 1′, with the following exceptions.

The first coating layer was formed from the coating liquid (7) illustrated below and no third coating layer was formed.

Coating Liquid (7)

A aqueous dispersion having a concentration of 10% by mass was prepared from 100 parts by mass of silica fine particles C mixed with 25 parts by mass of a binder consisting of polyvinyl alcohol (trademark: PVA-135, polymerization degree: 3500, saponification degree: 98.5%, made by KURARAY K.K.).

The silica fine particles C were prepared as follows.

Wet process silica particles having average secondary particle size of 2.0 μm (trademark: NIPSIL HD, average primary particle size: about 0.013 μm, made by NIHON SILICA KOGYO K.K.) were dispersed in water and subjected to a pulverizing and procedure in which a combination of a pulverizing step using a sand grinder with a further pulverizing step using a pressure-applying homogenizer was repeatedly applied to the dispersion until the average particle size of the silica particle reached 0.4 μm, to provide an aqueous dispersion of the silica particles in a concentration of 10% by mass.

Production of Ink Jet Recording Material

The coating liquid (7) was coated in a dry coating amount of 10 g/m² on a surface of the same substrate material as in Example 1 and dried to form a first coating layer. On the first coating layer, the same second coating layer as in Example 1 was formed. No third coating layer was formed. A comparative ink jet recording material was obtained.

### Comparative Example 9

An ink jet recording material was produced by the same procedures as in Example 1, with the following exceptions.

The first coating layer was formed from the coating liquid (8) as illustrated below, the second coating layer was formed from the above-mentioned coating liquid (2), and no third coating layer was formed.

Coating Liquid (8)

A aqueous dispersion having a concentration of 15% by mass was prepared from 100 parts by mass of a wet process silica having an average secondary particle size of 85 μm (trademark: NIPSIL NS-TR, average primary particle size: about 0.02 μm, made by NIHON SILICA KOGYO K.K.) mixed with 20 parts by mass of a binder consisting of polyvinyl alcohol (trademark: PVA-124, made by KURARAY K.K.) and 2 parts by mass of a cationic compound (trademark: SR-1001, made by SUMITOMO KAGAKUKOGYO K.K.).

Production of Ink Jet Recording Material

The coating liquid (8) was coated in a dry coating amount of 10 g/m on a surface of the same substrate material as in Example 1 and dried to form a first coating layer. On the first coating layer, a second coating layer was formed in such a manner that on the first coating layer, an aqueous solution of 6% by mass of borax was coated in a dry coating amount of 0.6 g/m² and then the coating liquid (2) was further coated in a dry coating amount of 5 g/m² by the wet-on-wet method, to form a second coating layer. No third coating layer was formed. A comparative ink jet recording material was obtained.

Test and Evaluation

Each of the ink jet recording materials produced in Examples 1 to 9 and Comparative Examples 1 to 9 was subjected to tests and evaluations of peaks appearing in the pore size distribution curves of the first and second coating layers, an ink absorption of the ink receiving layer, uniformity and color density of the recorded images, gloss of the ink receiving layer surface, aptitude to pigment ink (pigment ink aptitude) and fretting resistance of pigment ink images (fretting resistance of pigment images), in the following measurement methods. The ink jet recording on the recording material was carried out by using a trade available ink jet printer (model: PM-950C, printing mode: clear mode of paper sheet for PM photograph; made by EPSON Co.)

Ink Absorption (Uniformity of Images)

A sample of the ink jet recording material was subjected to a solid printing in green color, and uniformity of the solid printing was observed by the naked eye and evaluated in four classes shown below. The printing blotches were generated in the case where while earlier ink droplets jetted toward the ink receiving layer surface were not completely absorbed in a coating layer in the ink jet recording material, later ink droplets applied to the ink receiving layer surface were superposed on the earlier ink dots. When the ink absorption rate of the ink receiving layer is low, the printing blotches were significantly appeared.

| Class | Uniformity |
|---|---|
| 4 | No printing blotches appear. |
| 3 | Practically usable although certain printing blotches appear. |
| 2 | Practical usability is low due to printing blotches. |
| 1 | Significant printing blotches appear. |

Uniformity of Images (Roundness of Dots)

On a recording material for testing, images of ISO-400 (High precision color digital standard image data ISO/JIS-SCIP, page 13, Name of image: Fruit basket) were printed and the uniformity of the images (background part) was observed by the naked eye and the results were evaluated as follows.

When the dots are in a true round form, the images formed from a plurality of dots superposed on each other are uniform. However, the lower the roundness of the dots, the lower the uniformity of the resultant images.

| Class | Uniformity |
|---|---|
| 2 | Images are uniform. No blotches are found. (Dots are in true round |
| | form, and edge portions of images are smooth) |
| l | Images are uneven, blotches are found. (Dots are not in true round |
| | form, and the edge portions of images are rough. |

Color Density of Images

A sample of the ink jet recording material was solid printed in black color, and the color density of the solid printed black color was measured by Macbeth reflection color density meter (model: Macbeth RD-920).

Gloss

On a sample of the recording material, an ISO-400 image (┌High precision color digital standard image data ISO/JIS-SCID, page 13, image name: Fruit basket) was printed.

The printed part of the recording material was observed in transverse direction with the naked eye and the observation results were evaluated in four classes as follows.

| Class | Gloss |
|---|---|
| 4 | Identical to gloss of silver salt photograph |
| 3 | Slightly lower than the gloss of silver salt photograph |
| 2 | Identical to gloss of conventional glossy ink jet recording material |
| 1 | Identical to gloss of conventional mat ink jet recording material |

Pigment Ink Aptitude and Fretting Resistance of Pigment Images

To evaluate an aptitude of a recording material to pigment ink and a fretting resistance of the pigment images, a sample of the recording material was printed with an ISO-400 image (High precision color digital standard image data ISO/JIS-SCID, page 13, image name: Fruit basket).

The printed images was evaluated as follows.

(a) Pigment Ink Aptitude

The aptitude of the recording material to pigment ink was evaluated in response to the uniformity of the printed images.

| Class | Uniformity |
|---|---|
| 3 | The images are uniform. No blotches appear. |
| 2 | Practically usable, although certain blotches appear on images. |
| 1 | Practical usability is low due to significant blotches appearing in |
| | images. |

(b) Fretting Resistance of Pigment Ink Images

The above-mentioned images on the recording material was let to stand for 24 hours after printing, then the images were rubbed with a cotton stick and the resistance of the images to fretting was evaluated as follows.

| Class | Fretting resistance |
|---|---|
| 3 | No change appear in images. |
| 2 | Practically usable, although portions of pigment in images are |
| | removed. |
| 1 | Practical usability is low due to poor resistance to fretting. |

The results of tests and evaluations are shown in Table 1.

TABLE 1

| | | Item | | | | | | | |
|---|---|---|---|---|---|---|---|---|---|
| | | | | | Pore size at | | | | |
| | | | | | peak in pore | | | | |
| | | | | | size distribution | | | | |
| | | | | | curve | | | | |
| | | Ink | Image | Color density | First coating | Second coating | | Aptitude to | Fretting resistance |
| Example No. | | absorption | uniformity | of image | layer (μm) | layer (μm) | Gloss | pigment ink | of pigment images |
| Example | 1 | 4 | 2 | 2.52 | 0.008 | 0.02 | 4 | 3 | 3 |
| | | | | | 0.9 | | | | |
| | 2 | 4 | 2 | 2.49 | 0.008 | 0.02 | 4 | 3 | 2 |
| | | | | | 0.9 | | | | |
| | 3 | 4 | 2 | 2.60 | 0.008 | 0.02 | 4 | 3 | 2 |
| | | | | | 0.9 | | | | |
| | 4 | 4 | 2 | 2.45 | 0.015 | 0.02 | 4 | 3 | 3 |
| | | | | | 2.0 | | | | |
| | 5 | 4 | 2 | 2.47 | 0.012 | 0.02 | 4 | 3 | 3 |
| | | | | | 1.5 | | | | |
| | 6 | 4 | 2 | 2.54 | 0.008 | 0.02 | 4 | 3 | 3 |
| | | | | | 0.9 | | | | |
| | 7 | 3 | 2 | 2.62 | 0.008 | 0.008 | 4 | 3 | 3 |
| | | | | | 0.9 | | | | |
| | 8 | 4 | 2 | 2.55 | 0.008 | 0.015 | 4 | 3 | 3 |
| | | | | | 0.9 | | | | |
| | 9 | 4 | 2 | 2.37 | 0.008 | 0.02 | 4 | 3 | 3 |
| | | | | | 0.9 | | | | |
| Comparative | 1 | 4 | 1 | 1.65 | 0.015 | — | 1 | 2 | 3 |
| Example | | | | | 2.0 | | | | |
| | 2 | 2 | 2 | 2.44 | 0.02 | — | 2 | 3 | 3 |
| | 3 | 1 | 2 | 2.43 | 0.02 | — | 2 | 3 | 3 |
| | 4 | 4 | 1 | 2.07 | 0.015 | 0.025 | 1 | 1 | 3 |
| | | | | | 2.0 | | | | |
| | 5 | 1 | 2 | 2.45 | 0.015 | 0.025 | 2 | 3 | 2 |
| | | | | | 1.7 | | | | |
| | 6 | 2 | 2 | 2.45 | 0.015 | 0.02 | 4 | 3 | 3 |
| | | | | | 2.0 | | | | |
| | 7 | 4 | 1 | 1.65 | 0.02 | 0.015 | 1 | 2 | 3 |
| | | | | | | 2.0 | | | |
| | 8 | 2 | 2 | 2.39 | 0.065 | 0.02 | 2 | 3 | 3 |
| | 9 | 2 | 2 | 2.10 | 18 | 0.015 | 1 | 3 | 3 |

Table 1 clearly shows that the ink jet recording materials produced in Examples 1 to 9 in accordance with the present invention exhibited a good ink absorption, a very good uniformity of images, and simultaneously had a high color density of images and a high gloss which were attained by appropriately selecting the size of pigment particles contained in the coating layers and the methods of producing the pigment particles. Thus, they are very useful for practice. Also, even when printed by using a pigment ink printer, on the recording materials of Examples 1 to 9, the recorded pigment images exhibited a high uniformity and a fretting resistance.

### Example 10

An ink jet recording material was produced by the following procedures.

(1) Substrate Material

The same substrate material as in Example 1 was employed.

(2) Preparation of Coating Liquid (9) for First Coating Layer

Coating Liquid (11)

An aqueous dispersion (concentration: 15% by mass) was prepared from a mixture of 100 parts by mass of wet process silica particles (trademark: Finesil F-80, average primary particle size: about 0.009 μm, average secondary particle size: 1.5 μm, made by TOKUYAMA K.K.) with 30 parts by mass of a binder consisting of polyvinyl alcohol (trademark: PVA-124, made by KURARAY K.K.), 2 parts by mass of a cationic compound, namely diallyldimethyl ammonium chloride-acrylamide copolymer (trademark: PAS-J-81, made by NITTOBO K.K.) and 0.2 part by mass of a dispersing agent (trademark: Aron SD-10, made by TOA GOSEI K.K.).

(3) Preparation of Coating Liquid (12)

Coating Liquid (12)

An aqueous dispersion having a concentration of 8% by mass was prepared from a mixture of 100 parts by mass of the silica fine particles (A) with 20 parts by weight of a binder consisting of polyvinyl alcohol (trademark: PVA-135, polymerization degree: 3500, saponification degree: 98.5%, made KURARAY K.K.).

(4) Preparation of Coating Liquid (13) for Third Coating Layer

Coating Liquid (13)

An aqueous dispersion having a concentration of 5% by mass was prepared from a mixture of 100 parts by mass of the alumina fine particles (B) with 5 parts by mass of a binder consisting of polyvinyl alcohol (trademark: PVA-135, polymerization degree: 3500, saponification degree: 98.5%, made by KURARAY K.K.) and 3 parts by mass of stearic amide.

(5) A surface of the substrate material (coated paper sheet) was coated with the coating liquid (11) for first coating layer and dried to form a first coating layer having a dry amount of 10 g/m². The first coating layer was coated with an aqueous solution of 3% by mass of borax in a dry amount of 0.15 g/m² and further with the coating liquid (12) for second coating layer is a dry amount of 5 g/m² by a wet-on wet method in which two or more layers are coated in such a manner that while the undercoat layer is kept in wetted condition, an uppercoat layer is coated on the undercoat layer, and then the coated layers were dried to form a second coating layer.

On the second coating layer, the coating liquid (13) for third coating layer was coated in a dry amount of 1 g/M² and while the coating liquid (3) layer was kept in wetted condition, the coating liquid (3) layer was brought into contact under pressure with a mirror-finished drum at a temperature of 100° C. and dried and the dried third coating layer was released from the drum. An ink jet recording material was obtained.

### Example 11

An ink jet recording material was produced by the same procedures as in Example 10, with the following exceptions.

The coating liquid (13) for the third coating layer was replaced by the coating liquid (14) prepared as follows.

Coating Liquid (14)

An aqueous dispersion having a concentration of 5% by mass was prepared from a mixture of 100 parts by mass of primary colloidal silica particles (trademark: ST-OL, average particle size of 0.145 μm), made by NISSAN KAGAKU K.K.) with 1 part by mass of a binder consisting of a silyl-modified polyvinyl alcohol (trademark: R-1130, polymerization degree: 1800, made by KURARAY K.K.) and 5 parts by mass of ammonium oleate.

### Example 12

An ink jet recording material was produced by the same procedures as in Example 10, with the following exceptions.

In the coating liquid (13) for the third coating layer, the alumina fine particles (B) were replaced by pseudo beomite fine particles (trademark: AS-3, average primary particle size: 0.05 μm, average secondary particle size: 0.4 μm, made by SHOKUBAI KAGAKU K.K.).

Each of the ink jet recording materials of Examples 10 to 12 was subjected to the above-mentioned tests and evaluations.

The results are shown in Table 2.

TABLE 2

| | | Item | | | | | |
|---|---|---|---|---|---|---|---|
| | | | | | Pore size at | | |
| | | | | | peak of pore | | |
| | | | | | size | | |
| | | | | | distribution | | |
| | | | | | curve | | |
| | | | | Color | First | Second | |
| | | Ink | Unifor- | density | coating | coating | |
| | | absorp- | mity of | of | layer | layer | |
| Example | | tion | images | images | (μm) | (μm) | Gloss |
| Example | 10 | 4 | 2 | 2.52 | 0.008 | 0.02 | 4 |
| | | | | | 0.9 | | |
| | 11 | 4 | 2 | 2.49 | 0.008 | 0.02 | 4 |
| | | | | | 0.9 | | |
| | 12 | 4 | 2 | 2.45 | 0.008 | 0.02 | 4 |
| | | | | | 0.9 | | |

Table 2 clearly shows that the ink jet recording materials of Examples 10 to 12 in accordance with the present invention exhibited a good ink absorption and a very good uniformity of images. Also, these recording materials had a high color density of recorded images and a high gloss attained by appropriately selecting the size of pigment particles contained in the coating layers and the method of producing the pigment particles, and thus are very useful for practice.

### Example 13

An ink jet recording material was produced by the following procedures.

(1) Substrate Material

The same substrate material as in Example 1 was employed.

(2) Preparation of Coating Liquid (21) for First Coating Layer

Coating Liquid (21)

An aqueous dispersion (concentration: 15% by mass) was prepared from a mixture of 100 parts by mass of wet process silica particles (trademark: Finesil F-80, average primary particle size: about 0.009 μm, average secondary particle size: 1.5 μm, made by TOKUYAMA K.K.) with 30 parts by mass of a binder consisting of polyvinyl alcohol (trademark: PVA-124, made by KURARAY K.K.), 2 parts by mass of a cationic compound, namely diallyldimethyl ammonium chloride-acrylamide copolymer (trademark: PAS-J-81, made by NITTOBO K.K.) and 0.2 part by mass of a dispersing agent (trademark: Aron SD-10, made by TOA GOSEI K.K.).

(3) Preparation of Coating Liquid (22)

Coating Liquid (22)

An aqueous dispersion having a concentration of 8% by mass was prepared from a mixture of 100 parts by mass of the silica fine particles (A) with 20 parts by weight of a binder consisting of polyvinyl alcohol (trademark: PVA-135, polymerization degree: 3500, saponification degree: 98.5%, made by KURARAY K.K.).

(4) Preparation of Coating Liquid (23) for Third Coating Layer

Coating Liquid (23)

An aqueous dispersion having a concentration of 5% by mass was prepared from a mixture of 100 parts by mass of the alumina fine particles (B) with 5 parts by mass of a binder consisting of polyvinyl alcohol (trademark: PVA-135, polymerization degree: 3500, saponification degree: 98.5%, made by KURARAY K.K.) and 3 parts by mass of stearic amide.

(5) A surface of the substrate material was coated with the coating liquid (21) for first coating layer by using an airknife coater and dried, by blowing hot air having a temperature of 140° C. at a air flow speed of 20 m/sec for 30 seconds, to form a first coating layer having a dry amount of 10 g/m². The first coating layer was coated with the coating liquid (12) for second coating layer in a dry amount of 5 g/m² by using a die coater and, immediately, after the coating, electron beam was irradiated toward the coating liquid (22) layer for the second coating layer by using an electron beam irradiation apparatus (Electro curtain, made by EST CO.) at an acceleration voltage of 175 kV at an exposure dose of 5 Mrad. The electron beam-irradiated coating liquid (22) layer was in the state of a jelly and thus it was confirmed that the coating liquid (22) was hydrogenated.

The gelated coating liquid (22) layer was dried with hot air flow at 100° C. at an air flow speed of 10 m/sec for 3 minutes to form a second coating layer.

On the second coating layer, the above-mentioned coating liquid (23) for third coating layer was coated in a dry amount of 1 g/m², and while the coating liquid (23) layer is kept in wetted condition, this layer was brought into contact with a mirror-finished drum at a temperature under pressure, dried and released from the drum.

An ink jet recording material was obtained.

### Example 14

An ink jet recording material was produced by the same procedures as in Example 13, with the following exceptions.

The coating liquid (23) for the third coating layer was replaced by the coating liquid (24) prepared as follows.

Coating Liquid (24)

An aqueous dispersion having a concentration of 5% by mass was prepared from a mixture of 100 parts by mass of primary colloidal silica particles (trademark: ST-OL, average particle size of 0.145 μm), made by NISSAN KAGAKU K.K.) with 1 part by mass of a binder consisting of a silyl-modified polyvinyl alcohol (trademark: R-1130, polymerization degree: 1800, made by KURARAY K.K.) and 5 parts by mass of ammonium oleate.

### Example 15

An ink jet recording material was produced by the same procedures as in Example 14, with the following exceptions.

In the preparation of the second coating layer, while the coating liquid (22) layer for a second coating layer was kept in a gel condition and a wetted condition, this layer was brought into contact with a mirror-finished drum having a surface temperature of 90° C. under pressure, dried for one minute and separated from the drum.

Test and Evaluation

Each of the ink jet recording materials of Examples 13 to 15 was subjected to the same tests and evaluations as in Example 1.

Further, the following test and evaluation was carried out.

Height of Curling

A sample of the ink jet recording material was cut into A4 size sheets, placed on a glass plate so that the ink receiving layer faced up and conditioned in a room at a temperature of 15° C. at a relative humidity of 40% for 24 hours, and then the heights of the curled corner portions of the recording material from the glass plate surface were measured.

The larger the curl height, the more significant the degree of curling of the recording material. When the curl height is 20 nm or more, a problem that, in a printing step, the recording material can not smoothly pass through the printer, occurs.

The results of test and evaluation are shown in Table 3.

TABLE 3

| | | | | Pore size at | | | | |
|---|---|---|---|---|---|---|---|---|
| | | | | peak of pore size | | | | |
| | | | | distribution curve | | | | |
| | | | | First | Second | | | |
| | | | Color | coating | coating | | Drying | Curl |
| Item | Ink | Uniformity | density | layer | layer | | time | height |
| Example | absorption | of images | of images | (μm) | (μm) | Gloss | (min) | (mm) |
| Example | | | | | | | | |
| 13 | 4 | 2 | 2.55 | 0.008 0.09 | 0.02 | 4 | $3 \frac{2}{3}$ | 5 |
| 14 | 4 | 2 | 2.50 | 0.008 0.9 | 0.02 | 4 | $3 \frac{2}{3}$ | 3 |
| 15 | 4 | 2 | 2.62 | 0.008 0.9 | 0.02 | 4 | $1 \frac{2}{3}$ | 0 |

Table 3 clearly shows that the ink jet recording material of Examples 13 to 15 in accordance with the present invention exhibited a good ink absorption, a good curling-preventing property and could be printed at a high recording speed. Also, in the recording material, the uniformity of images (roundness of dots) is very good, and gloss and color density of images could be appropriately controlled, and the production cost was low. Although the examples as mentioned above did not illustrate this, the recording materials of Examples 13 to 15 could be recorded by a pigment ink printer (for example, Printer PM4000 PX, made by EPSON) with the similar effects to those as shown above.

### Example 16

An ink jet recording material was produced by the following procedures.

(1) Substrate Material

A paper sheet having a air permeation resistance of 70 seconds/100 ml and a basis mass of 209 g/m² was employed.

(2) Preparation of Coating Liquid (31) for First Coating Layer

Coating Liquid (31)

An aqueous dispersion (concentration: 15% by mass) was prepared from a mixture of 100 parts by mass of wet process silica particles (trademark: Finesil F-80, average primary particle size: about 0.009 μm, average secondary particle size: 1.5 μm, made by TOKUYAMA K.K.) with 30 parts by mass of a binder consisting of polyvinyl alcohol (trademark: PVA-124, made by KURARAY K.K.), and 2 parts by mass of a cationic compound, namely diallyldimethyl ammonium chloride-acrylamide copolymer (trademark: PAS-J-81, made by NITTOBO K.K.).

(3) Preparation of Coating Liquid (32)

Coating Liquid (32)

An aqueous dispersion having a concentration of 5% by mass was prepared from a mixture of 100 parts by mass of gas phase process alumina fine particles (trademark: PG 003, made by CABOT CO.,) with 5 parts by weight of a binder consisting of polyvinyl alcohol (trademark: PVA-135, polymerization degree: 3500, saponification degree: 98.5%, made by KURARAY K.K.), and 3 parts by mass of stearic amide.

(4) Preparation of Coating Liquid (33) for Third Coating Layer

Coating Liquid (33)

An aqueous dispersion having a concentration of 5% by mass was prepared from a mixture of 100 parts by mass of the gas phase process alumina fine particles (trademark: PG 003, made by CABOT CO.,) with 5 parts by mass of a binder consisting of polyvinyl alcohol (trademark: PVA-135, polymerization degree: 3500, saponification degree: 98.5%, made by KURARAY K.K.) and 3 parts by mass of stearic amide.

Production of Ink Jet Recording Material

A surface of the substrate material was coated with the coating liquid (31) for first coating layer by using an airknife coater and dried to form a first coating layer having a dry amount of 10 g/m². The first coating layer was coated with an aqueous solution of 3% by mass of borax in a dry amount of 0.15 g/m² and further with the coating liquid (32) for second coating layer in a dry amount of 5 g/m² by a wet-on wet method in which two or more layers are coated in such a manner that while the undercoat layer is kept in wetted condition, an uppercoat layer is coated on the undercoat layer, by using a die coater, and then the coated layers were dried to form a second coating layer.

On the second coating layer, the coating liquid (33) for third coating layer was coated in a dry amount of 1 g/m² and while the coating liquid (33) layer was kept in wetted condition, the coating liquid (33) layer was brought into contact under pressure with a mirror-finished drum at a temperature of 100° C. and dried and the dried third coating layer was released from the drum. An ink jet recording material was obtained.

The resultant recording material exhibited an air permeation resistance of 265 seconds/100 m, an air permeation resistance of a laminate of the substrate material and the first coating layer of 72 seconds/100 ml, an air permeation resistance of a laminate of the substrate material with the first and second coating layers of 235 seconds/100 ml, a ratio in air permeation resistance of the recording material to the substrate material of 3.78 and a ratio in air permeation resistance of the laminate of the substrate material with the first coating layer to the substrate material of 3.68.

### Example 17

An ink jet recording material was produced by the same procedures as in Example 16, with the following exceptions.

The substrate material was a laminate paper sheet prepared by laminating a polyethylene resin layer having a thickness of 15 μm on a back surface of a paper sheet having an air permeation resistance of 25 seconds/100 ml and a basis mass of 209 g/m².

Also, the third coating layer was formed from a coating liquid (34) prepared as follows.

Coating Liquid (34)

An aqueous dispersion having a concentration of 5% by mass was prepared from a mixture of 100 parts by mass of primary colloidal silica particles (trademark: ST-OL, average particle size of 0.045 μm), made by NISSAN KAGAKU K.K.) with 1 part by mass of a binder consisting of a silyl-modified polyvinyl alcohol (trademark: R-1130, polymerization degree: 1800, made by KURARAY K.K.) and 5 parts by mass of ammonium oleate.

The resultant recording material exhibited an air permeation resistance of 275 seconds/100 ml and an air permeation resistance of a laminate of the first coating layer on the substrate material of 72 seconds/100 ml. The ratio in air permeation resistance of the resultant recording material to the substrate material was 3.93 and the ratio in the air permeation resistance of the laminate of the first coating layer on the substrate material to the substrate material was 3.82.

The ink jet recording material of Examples 16 and 17 were subjected to the same tests and evaluations as in Example 13 and further to the following test and evaluation.

Beadings

The generation of beadings is greatly variable in response to the type of the printer, and often occur when the printing is carried out by using a printer or a photo printer capable of printing at a high speed, which have been recently become available in the trade.

The mechanism of generation of the beadings is the same as that of uneveness in printing, and the beadings are probably generated in green-color solid-printing using a green ink (yellow ink 100%+cyan ink 100%=200%).

When the beadings are generated, the printed green color exhibit a higher color density than 200%, for example, about 300%, and, in a portrait image, a neck portion cannot be clearly shown. In this test, the recording material is subjected to a green color solid printing by using a printer (trademark: Pixus 850, mode: Prophotopaper, standard) which generates beading, and the quality of the resultant print and the degree of beadings (uneveness in print) of the resultant print was evaluated as follows.

Class Resistance to Beadings

4 No beadings occur and the resultant solid print exhibits a good uniformity.
3 Little beadings are found, the uniformity of solid print is lower than in class 4, and the print is usable in practice.
2 Large beading are found, the uniformity of the solid print is bad, and the solid print may not be usable in practice.
1 Very large beadings are found.

The test results are shown in Table 4.

TABLE 4

| | | Item | | | | | | |
|---|---|---|---|---|---|---|---|---|
| | | | | | Pore size at | | | |
| | | | | | peak of pore | | | |
| | | | | | size distribution | | | |
| | | | | | curve | | | |
| | | Beading | Uniformity | Color density | First coating | Second coating | | Curl height |
| Example | | resistance | of images | of images | layer (μm) | layer (μm) | Gloss | (mn) |
| Example | 16 | 4 | 2 | 2.32 | 0.008 | 0.02 | 4 | 3 |
| | | | | | 0.9 | | | |
| | 17 | 4 | 2 | 2.51 | 0.008 | 0.02 | 4 | 5 |
| | | | | | 0.9 | | | |

Table 4 clearly illustrates that the ink jet recording materials of Examples 16 and 17 in accordance with the present invention exhibit a good curling-preventing property, a high beading-preventing property even at a high recording speed, a good ink absorption (ink absorption rate and ink absorption capacity), a very high uniformity of images (dot roundness), a high gloss, a high color density of images and a high clarity of images. Although the Examples are silent about this, it was confirmed that the ink jet recording materials of Examples 16 and 17 could record clear pigment ink images even when a pigment ink printer (for example, trademark: 4000Px, made by EPSON K.K.) is used.

### INDUSTRIAL APPLICABILITY

The ink jet recording material of the present invention has excellent dye and pigment ink absorptions (ink absorption rate and ink absorption capacity) and can record accurate and clear images having a high color density even in a high speed printing. Therefore, the ink jet recording material of the present invention exhibits a high applicability for industrial practice.

1. An inkjet recording material comprising a substrate material and an ink-receiving layer which comprises a first coating layer formed on the front surface of the substrate material and comprising a pigment and a binder, a second coating layer formed on the first coating layer, comprising a pigment and a binder and being in one or more-layered form, and a third coating layer formed on the second coating layer,
wherein the third coating layer comprises a pigment comprising, as a principal component, at least one member from the group consisting of primary colloidal particles having an average particle size of 0.01 to 0.06 μm, and fine alumina and pseudo boehmite particles having an average particle size of 0.01 to 1 μm.

2. The ink jet recording material as claimed in claim 1, wherein the first coating layer exhibits a pore size-distribution curve having at least one peak located in the range of from 0.1 to 10 μm of the pore size, and the second coating layer exhibits a pore size-distribution curve having a peak located in the range of about 0.06 μm or less of the pore size.

3. The ink jet recording material as claimed in claim 1, wherein the first coating layer exhibits a pore size-distribution curve having at least one peak located in each of the ranges of 0.04 μm or less and from 0.2 to 5 μm of the pore size, and the second coating layer exhibits a pore size-distribution curve having a peak located in the range of about 0.04 μm or less of the pore size.

4. The inkjet recording material as claimed in claim 1, wherein the binders for the first and second coating layers respectively and independently from each other comprise at least one member selected from the group consisting of polyvinyl alcohol, modified polyvinyl alcohols and cross-linked polyvinyl alcohols with a cross-linking compound.

5. The ink jet recording material as claimed in claim 1, wherein the binder contained in the second coating layer comprises cross-linked polyvinyl alcohol having a degree of polymerization of 2000 or more.

6. The ink jet recording material as claimed in claim 4, wherein the cross-linking compound with which the polyvinyl alcohol is cross-linked, is a boron-containing compound.

7. The inkjet recording material as claimed in claim 1, wherein the pigment contained in the first coating layer comprises, as a principal component, secondary pigment particles composed of agglomerates of primary particles having an average primary particle size of 0.003 to 0.04 μm and having an average secondary particle size of 0.7 to 3 μm; the pigment contained in the second coating layer comprises, as a principal component, secondary pigment particles composed of agglomerates of primary particles having an average primary particle size of 0.003 to 0.04 μm and having an average secondary particle size of 0.7 μm or less; and the pigment contained in the third coating layer comprises at least one member selected from the group consisting of the above-mentioned primary colloidal particles and alumina and pseudo boehmite fine particles.

8. The ink jet recording material as claimed in claim 1, wherein the pigment contained in the second coating layer comprises at least one member selected from the group consisting of silica, aluminum oxides and pseudo boehmite, and the second coating layer has a pore volume of 0.3 to 1 ml/g.

9. The ink jet recording material as claimed in claim 1, wherein the first and second coating layers comprise, as a pigment, silica, and the silica contained in the first coating layer is a wet process silica, and the silica contained in the second coating layer is a dry process silica.

10. The ink jet recording material as claimed in claim 8, wherein the silica contained in the second coating layer is included in agglomerate particles of the dry process silica particles with a cationic compound, and the silica-cationic compound agglomerate particles have an average particle size of 0.7 μm or less.

11. The ink jet recording material as claimed in claim 1, wherein the second coating layer has a smooth surface formed by pressing the second coating layer kept in a wetted condition onto a heater mirror-finished drum surface and drying the pressed layer.

12. The ink jet recording material as claimed in claim 1, wherein the third coating layer has a smooth surface formed by pressing the third coating layer kept in a wetted condition onto a heated mirror-finished drum surface and drying the pressed layer.

13. The ink jet recording material as claimed in claim 1, wherein the pigment contained in the second coating layer comprises at least one member selected form the group consisting of gas phase process silica, mesoporous silica, dispersed secondary silica particles having a specific surface area of 100 to 400 m²/g determined by a nitrogen absorption method, an average secondary particle size of 20 to 300 nm and a pore volume of 0.5 to 2.0 ml/g, aluminas and alumina hydrates.

14. The ink jet recording material as claimed in claim 1, wherein the pigment contained in the first coating layer comprises wet process silica fine particles;
the second coating layer comprises at least one member selected from the group consisting of gas phase process silica and mesoporous silica fine particles having an average particle size of 0.01 to 1 μm, secondary silica particles having a specific surface area of 100 to 400 m²/g determined by a nitrogen absorption method, an average secondary particle size of 20 to 300 nm and a pore volume of 0.5 to 2.0 ml/g, and alumina and alumina hydrate fine particles having an average particle size of 0.01 to 1 μm; and the third coating layer comprises at least one member selected from the group consisting of alumina and pseudo boehmite fine particles having an average particle size of 0.1 to 0.7 μm.

15. The ink jet recording material as claimed in claim 1, wherein the binder contained in the second coating layer is thickening-treated or cross linking-treated.

16. The ink jet recording material as claimed in claim 15, wherein the thickening or cross-linking treatment for the binder contained in the second coating layer is applied to a binder-containing coating liquid for forming the second coating layer simultaneously with the application of the coating liquid to the first coating or before the applied coating liquid in a step of drying exhibits a falling rate of drying.

17. The ink jet recording material as claimed in claim 15, wherein the thickening-treated or cross-linking-treated binder contained in the second coating layer comprises a hydrophilic resin hydrogelled by an electron beam-irradiation.

18. The ink jet recording material as claimed in claim 1, wherein the substrate material exhibit an air permeability of 500 seconds/100 ml or less, determined in accordance with JIS P 8117.

19. The ink jet recording material as claimed in claim 18, wherein the gas permeation resistance of the substrate material is in the range of from 10 to 200 seconds/100 ml.

20. The ink jet recording material as claimed in claim 1, having a total gas permeation resistance of 2 to 12 times that of the substrate material.

21. The ink jet recording material as claimed in claim 20, having a total gas permeation resistance of 2 to 12 times that of a laminate consisting of the substrate material and the first coating layer.

22. The ink jet recording material as claimed in any one of claims 1 to 21, further comprising an other coating layer formed on a back surface of the substrate material.

23. The ink jet recording material as claimed in claim 22, wherein the other coating layer is a laminated layer comprising a polyethylene.
